(19) United States
(12) Patent Application Publication
(10) Pub. No.: US 2025/0291050 A1
(43) Pub. Date: Sep. 18, 2025

(54) COMPOSITE SENSOR AND VEHICLE

(71) Applicant: Panasonic Automotive Systems Co., Ltd., Kanagawa (JP)

(72) Inventors: Manabu YUMINE, Osaka (JP); Junji SATO, Tokyo (JP); Noriaki SAITO, Tokyo (JP); Takaaki KISHIGAMI, Tokyo (JP); Kenji NAGATOMI, Osaka (JP)

(21) Appl. No.: 19/076,723

(22) Filed: Mar. 11, 2025

(30) Foreign Application Priority Data
Mar. 14, 2024 (JP) 2024-039976

(51) Int. Cl. G01S 13/86; G01S 13/87; H01Q 1/12; H01Q 1/38; H04N 23/54

(52) U.S. Cl. CPC G01S 13/867; G01S 13/872; H01Q 1/1271; H01Q 1/38; H04N 23/54

(57) ABSTRACT

The composite sensor of the present disclosure includes: a main body including a radar control circuitry, a camera control circuitry, a transceiver connected to the radar control circuitry, and an image sensor connected to the camera control circuitry; and an antenna section configured to be connected to the transceiver and separate from the main body.

### TECHNICAL FIELD

The present disclosure relates to a composite sensor and a vehicle, for example, to a composite sensor to configure to be mounted on a vehicle and a vehicle on which the composite sensor is mounted.

### BACKGROUND ART

In recent years, various sensors such as a camera and a radar are configured to be mounted on a vehicle. A radar uses a high-frequency millimeter wave or the like. Therefore, due to the characteristics of light or electromagnetic waves, both the camera and the radar have a detection range according to the installation location.

A composite sensor in which a camera and a radar are integrated into a single housing has been studied (see, for example, Patent Literatures (hereinafter, each referred to as PTL) 1 and 2).

### CITATION LIST

### Patent Literature

### PTL 1

Japanese Patent Application Laid-Open No. 2005-114542

### PTL 2

Japanese Unexamined Patent Application Publication (Translation of PCT Application) No. 2012-505115

### SUMMARY OF INVENTION

One non-limiting and exemplary embodiment of the present disclosure facilitates providing a composite sensor capable of preventing an increase in air resistance of a vehicle and constraint on the design of the vehicle, and vehicle equipped with the composite sensor.

A composite sensor according to an embodiment of the present disclosure includes: a main body including a radar control circuitry, a camera control circuitry, a transceiver connected to the radar control circuitry, and an image sensor connected to the camera control circuitry; and an antenna section configured to be connected to the transceiver and separate from the main body.

A vehicle according to an embodiment of the present disclosure includes, mounted thereon, a composite sensor including the following: a main body including a radar control circuitry, a camera control circuitry, a transceiver connected to the radar control circuitry, and an image sensor connected to the camera control circuitry; and an antenna section configured to be connected to the transceiver and separate from the main body.

According to an embodiment of the present disclosure, it is possible to prevent an increase in the air resistance of a vehicle and to prevent a constraint on the design of the vehicle.

### BRIEF DESCRIPTION OF DRAWINGS

FIG. 1 is a block diagram of a composite sensor;

FIG. 2 illustrates an image of the appearance of the composite sensor;

FIG. 3 illustrates an example in which a main body of the composite sensor is installed at a front corner on a roof of a vehicle, and an antenna section is configured to be installed in an L-shape at a corner of an upper portion of a windshield;

FIG. 4 illustrates an image of the appearance of the composite sensor;

FIG. 5 illustrates another example in which the main body is installed behind a transparent antenna section installed on the windshield;

FIG. 6 illustrates a region in which a transparent electrode is not wired in the composite sensor;

FIG. 7 illustrates a case where an obstacle is located in the distance when a center of a camera and a center of a radar are misaligned;

FIG. 8 illustrates a case where obstacles are located both far and near when the center of the camera and the center of the radar are misaligned;

FIG. 9 illustrates a case where obstacles are located both far and near when the center of the camera and the center of the radar coincide with each other;

FIG. 10 illustrates a configuration example of a composite sensor suitable for a MIMO (Multi Input Multi Output) antenna;

FIG. 11 illustrates another configuration example of the composite sensor;

FIG. 12 illustrates another configuration example of a composite sensor suitable for a MIMO antenna;

FIG. 13 illustrates an example of an arrangement of antennas and a camera when two transceivers are used;

FIG. 14 illustrates an image of the appearance of an appearance of the main body and the antenna sections when two transceivers are used in the main body;

FIG. 15 illustrates an image of the appearance of the main body and the antenna sections when two transceivers are used in the antenna section;

FIG. 16 illustrates an example of an arrangement of antennas and a camera when four transceivers are used;

FIG. 17 illustrates an image of the appearance of the main body and the antenna sections when four transceivers are used in the main body;

FIG. 18 illustrates an image of the appearance of the main body and the antenna sections when four transceivers are used in the antenna section;

FIG. 19 is an example in which the antenna installation regions are disposed in an L-shape;

FIG. 20 is an example in which the antenna installation regions are disposed in an L-shape;

FIG. 21 is an example in which the antenna installation regions are disposed in an L-shape;

FIG. 22 is an example in which the antenna installation regions are disposed in an L-shape;

FIG. 23 is an example in which the antenna installation regions are disposed in an L-shape;

FIG. 24 is an example in which the antenna installation regions are disposed in an L-shape;

FIG. 25 illustrates an example in which one antenna system is configured with four antenna elements;

FIG. 26 illustrates an example in which one antenna system is configured with six antenna elements;

FIG. 27 illustrates an example in which one antenna system is configured with eight antenna elements;

FIG. 28 illustrates an example in which one antenna system is configured with two rows each including eight antenna elements;

FIG. 29 illustrates an example in which one antenna system is configured with four rows each including eight antenna elements;

FIG. 30 illustrates an example of an arrangement of transmitting antennas and receiving antennas that constitute a MIMO antenna;

FIG. 31 illustrates another example of the offset of the transmitting antennas;

FIG. 32 illustrates still another example of the offset of the transmitting antennas;

FIG. 33 illustrates the arrangement of the transmitting antennas and the receiving antennas represented by phase centers;

FIG. 34 illustrates a virtual receiving antenna arrangement;

FIG. 35 illustrates simulated angle measurement results;

FIG. 36 illustrates an example of an arrangement of antennas fed with power from four transceivers;

FIG. 37 illustrates the arrangement of the antennas in a simplified manner;

FIG. 38A illustrates a virtual receiving antenna arrangement;

FIG. 38B illustrates a virtual receiving antenna arrangement;

FIG. 39 illustrates the simulated angle measurement results;

FIG. 40 illustrates another example of an arrangement of antennas fed with power from four transceivers;

FIG. 41 illustrates the arrangement of the antennas described in a simplified manner;

FIG. 42A illustrates a virtual receiving antenna arrangement;

FIG. 42B illustrates a virtual receiving antenna arrangement;

FIG. 43 illustrates the simulated angle measurement results;

FIG. 44 illustrates another example of an arrangement of antennas fed with power from two transceivers;

FIG. 45 illustrates the arrangement of the antennas in a simplified manner;

FIG. 46 illustrates a virtual receiving antenna arrangement;

FIG. 47 illustrates the simulated angle measurement results;

FIG. 48 illustrates another example of an arrangement of antennas fed with power from four transceivers;

FIG. 49 illustrates the arrangement of the antennas in a simplified manner;

FIG. 50 illustrates a virtual receiving antenna arrangement;

FIG. 51 illustrates the simulated angle measurement results;

FIG. 52 illustrates another example of an arrangement of antennas fed with power from two transceivers;

FIG. 53 illustrates the arrangement of the antennas in a simplified manner;

FIG. 54 illustrates a virtual receiving antenna arrangement;

FIG. 55 illustrates the simulated angle measurement results;

FIG. 56 illustrates an example in which antennas fed with power from two transceivers are disposed in an L-shaped antenna installation region;

FIG. 57 illustrates the arrangement of the antennas in a simplified manner;

FIG. 58 illustrates a virtual receiving antenna arrangement of opening antennas;

FIG. 59 illustrates the simulated angle measurement results;

FIG. 60 illustrates an example in which antennas fed with power from four transceivers are arranged in an L-shaped antenna installation region;

FIG. 61 illustrates the arrangement of the antennas in a simplified manner;

FIG. 62 illustrates a virtual receiving antenna arrangement;

FIG. 63 illustrates the simulated angle measurement results;

FIG. 64 illustrates an example in which an offset is provided between a transmitting antenna and a receiving antenna of the other antenna;

FIG. 65 illustrates a detection range when a camera and a radar are installed at a upper portion of a vehicle and a detection range when a camera and a radar are installed at the lower portion of the vehicle;

FIG. 66 illustrates a detection range when a camera and a radar are installed at the right end of a vehicle and a detection range when a camera and a radar are installed at the center of the vehicle; and

FIG. 67 illustrates a detection range when a camera and a radar are installed at the right end of a vehicle and a detection range when a camera and a radar are installed at the center of the vehicle.

### DESCRIPTION OF EMBODIMENTS

Hereinafter, embodiments of the present disclosure will be described in detail with reference to the accompanying drawings. The embodiments described below are examples, and the present disclosure is not limited to the embodiments described below.

Any unnecessarily detailed description may be omitted. For example, a detailed description of a matter already well known in the art or a description overlapping substantially with an identical configuration may be omitted. This is to avoid the unnecessary redundancy of the following description and to facilitate understanding of those skilled in the art.

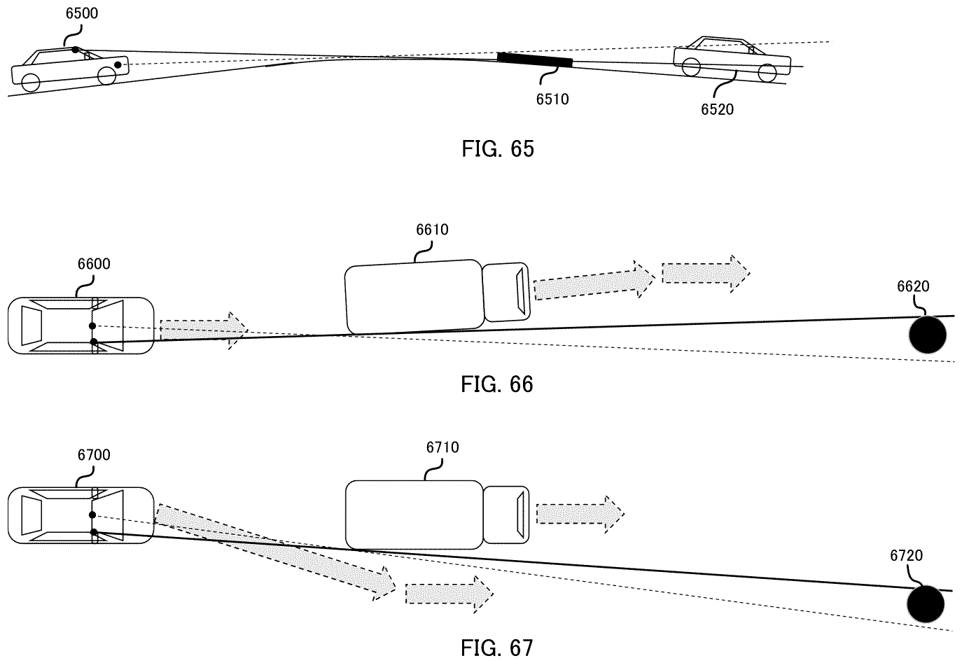

FIG. 65 illustrates vehicle 6500 traveling on a crest portion (a portion where the slope changes from ascending to descending) such as near the top of a hill. When a composite sensor configured to be mounted on vehicle 6500 is installed on the upper portion of the vehicle, the composite sensor can detect an area above the solid line, and when the composite sensor is installed on the lower portion of the vehicle, the composite sensor can detect an area above the dotted line.

For this reason, when the composite sensor is installed at the lower portion of vehicle 6500, it is difficult for the composite sensor to detect a low obstacle such as fallen object 6510, and it is also difficult for the composite sensor to detect vehicle 6520 ahead of the top of the hill unless vehicle 6520 approaches closer than the state in FIG. 65.

Accordingly, it is effective to install a composite sensor including a camera and a radar on the upper portion of a vehicle.

In FIG. 66, when the composite sensor is installed at the right end of vehicle 6600, it is possible to detect obstacle 6620 located on the right side of the solid line in spite of the presence of vehicle 6610 ahead, but when the composite sensor is installed at the center of vehicle 6600, it is difficult to detect obstacle 6620 located on the left side of the dotted line due to the presence of front vehicle 6610.

Therefore, in a case where vehicle 6610 in front changes lanes to avoid obstacle 6620 ahead, when composite sensors are installed at both ends of the left and right sides of vehicle 6600, obstacle 6620 can be recognized before vehicle 6610 in front changes lanes. Therefore, vehicle 6600 can also change lanes early. However, when the composite sensor is installed at the center of vehicle 6600, it is difficult for the composite sensor to recognize obstacle 6620 until after vehicle 6610 in front has performed a lane change, and thus, there is a possibility that the lane change of vehicle 6600 may be delayed.

In FIG. 67, in a case where vehicle 6700 changes lanes to overtake vehicle 6710 in front, when the composite sensor is installed at the right end of vehicle 6700, it is possible to recognize obstacle 6720 before the lane change (see the solid line), and thus, it is possible to determine not to perform the lane change. However, when the composite sensor is installed at the center of vehicle 6700, it is difficult for the composite sensor to recognize obstacle 6720 until after vehicle 6700 has changed lanes (see the dotted line), and thus, vehicle 6700 should interrupt the overtaking of preceding vehicle 6710 after changing lanes.

Regarding FIGS. 66 and 67, a similar problem occurs in a case where the composite sensor is installed at the left end of the vehicle.

Accordingly, it is effective to install composite sensors each including a camera and a radar at the left and right ends of the vehicle in the upper portion of the vehicle.

Hereinafter, an embodiment of the present disclosure will be described with reference to the drawings.

### <Configuration>

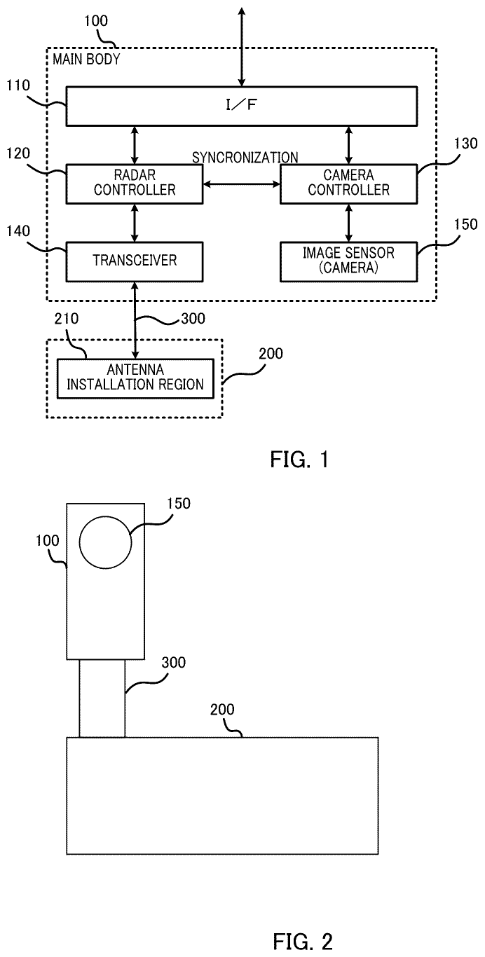

The composite sensor illustrated in FIG. 1 is configured to be mounted on, for example, a vehicle.

The composite sensor includes main body 100, antenna section 200, and cable 300. Main body 100 includes interface 110, radar controller (radar control circuitry) 120, camera controller (camera control circuitry) 130, transceiver 140, and image sensor 150. Antenna section 200 includes an antenna in antenna installation region 210. The vehicle may be equipped with a plurality of composite sensors.

Interface 110 is connected to radar controller 120 and camera controller 130, and communicates with the outside of the composite sensor, such as an electronic control unit (ECU) of a vehicle. Interface 110 multiplexes the result acquired by the camera and the result acquired by the radar, and transmits the multiplexed result to the ECU.

Radar controller 120 communicates with interface 110 and transceiver 140. Radar controller 120 performs control related to the radar of the composite sensor and controls an antenna configured to be installed in antenna installation region 210 of antenna section 200 that is separate from the main body. Radar controller 120 synchronizes with camera controller 130.

Camera controller 130 communicates with interface 110 and image sensor 150. Camera controller 130 performs control related to the camera of the composite sensor and controls image sensor 150. Camera controller 130 synchronizes with radar controller 120.

Transceiver 140 supplies power to the antenna in antenna installation region 210 of antenna section 200, which is separate from the main body, based on the control signal from radar controller 120.

Image sensor 150 (hereinafter, referred to as “camera”) includes an image sensor, such as a charge coupled device (CCD) sensor or a complementary metal oxide semiconductor (CMOS) sensor, and a lens.

Antenna section 200 is configured separately from main body 100 and is connected to transceiver 140 of main body 100 via cable 300. In antenna section 200, for example, an antenna in antenna installation region 210 is constituted by a transparent electrode and is disposed on a transparent film, and antenna section 200 is entirely transparent. Antenna section 200 does not have to be transparent.

Cable 300 is constituted by a flexible printed circuit (FPC), a transparent electrode wiring (transparent conductive film), or the like. Cable 300 supplies power from transceiver 140 to antenna section 200, and transmits electromagnetic waves received by antenna 210 in antenna section 200 to transceiver 140.

In the composite sensor illustrated in FIG. 2, main body 100 is connected with antenna section 200 via cable 300.

Since antenna section 200 is configured separately from main body 100 and the entire antenna section 200 is transparent, antenna section 200 can be configured to be installed in various locations.

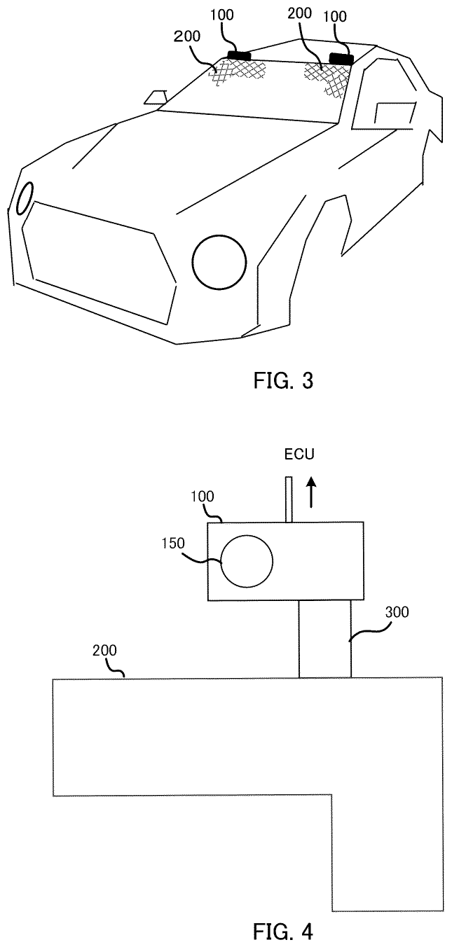

As illustrated in FIG. 3, the entire antenna section 200 is transparent, and therefore, antenna section 200 can be installed over a wide area without obstructing the driver's field of view. Antenna sections 200 are installed on both corners of the upper portion of the windshield of the vehicle each in an L-shape having a horizontally elongated part and a vertically elongated part. When antenna sections 200 are not L-shaped, antenna sections 200 may be installed on both corners of the upper portion of the windshield of the vehicle.

When the antenna in antenna installation region 210 can be installed over a wide area to increase the opening area, the efficiency of the antenna can be improved, and the distance measurement performance and the angle measurement performance of the radar can be enhanced.

FIG. 4 is an image of the appearance of the composite sensor illustrated in FIG. 3. In the composite sensor, main body 100 is connected with the L-shaped antenna section 200 via cable 300.

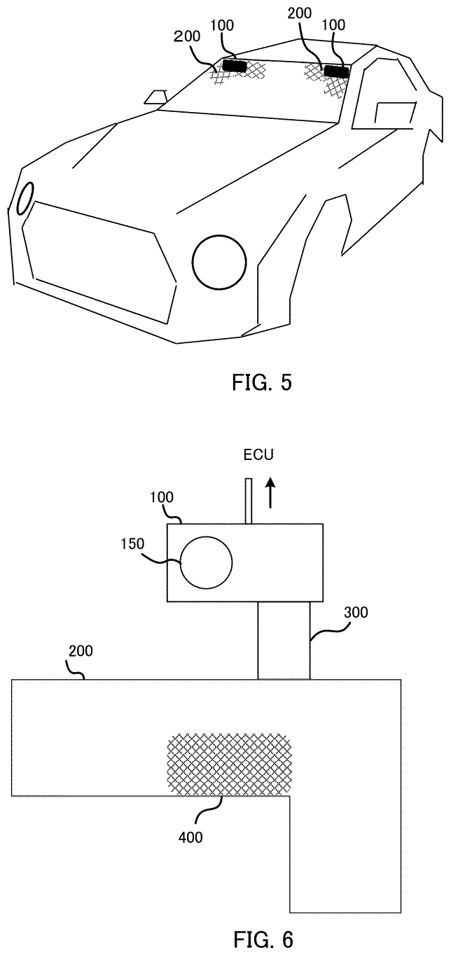

In FIG. 5, two main bodies 100 are installed at the front corners of the vehicle cabin, and each antenna section 200 is configured to be installed in front of main body 100 within a region indicated in an L-shape at the corner of an upper portion of the windshield. Antenna sections 200 are configured to be installed in regions indicated in an L-shape having a horizontally elongated part and a vertically elongated part, on both corners of the upper portion of the windshield of the vehicle. When antenna sections 200 are not L-shaped, antenna sections 200 may be installed on both corners of the upper portion of the windshield of the vehicle.

By installing main body 100 on the vehicle cabin, it is possible to reduce air resistance. Further, since antenna section 200 is transparent, antenna section 200 can be configured to be installed in front of camera 150. In addition, by installing antenna section 200 in front of main body 100 (camera 150), it is possible to align (or substantially align) the central axes of the camera and the radar, and the coordinate conversion processing can be omitted (or simplified) when integration processing (fusion processing) of the detection results from the camera and the radar is performed. Further, by including matching or overlapping portions between the detection range of the camera and the detection range of the radar, it becomes possible to perform integration processing (fusion processing) of the detection results from the camera and the radar, thereby improving detection performance.

In FIG. 6, in the composite sensor, main body 100 is connected with the L-shaped antenna section 200 via cable 300, and the L-shaped antenna section 200 includes region 400 in which an electrode (for example, an antenna and a power supply line) is not wired (hereinafter, also referred to as an electrode non-installation region). A case where antenna section 200 is not L-shaped is also possible.

For example, in antenna section 200, electrodes (for example, an antenna and a power supply line) may be wired in a region on a left side (hereinafter, also referred to as an antenna installation region) and a region on a right side (antenna installation region) whose horizontal directions (first directions) are different, with respect to electrode non-installation region 400 (FIG. 6).

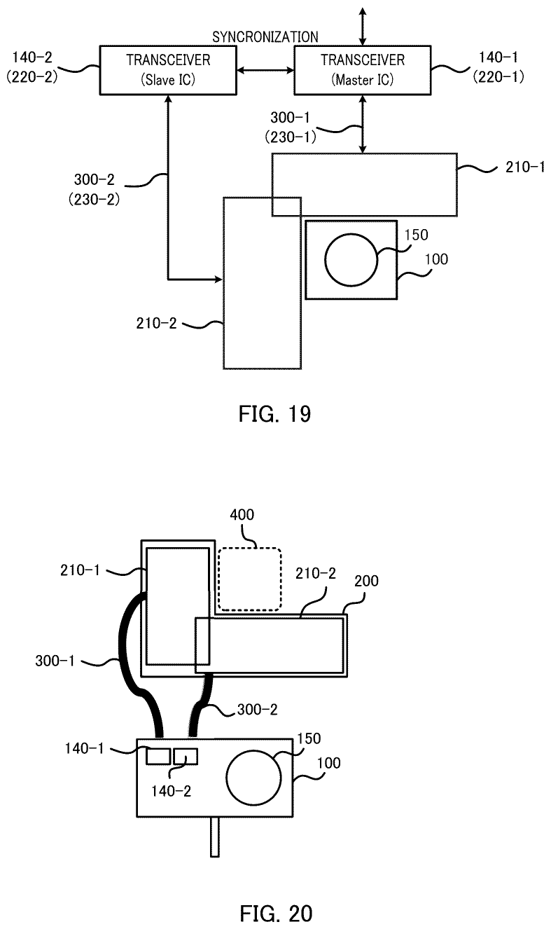

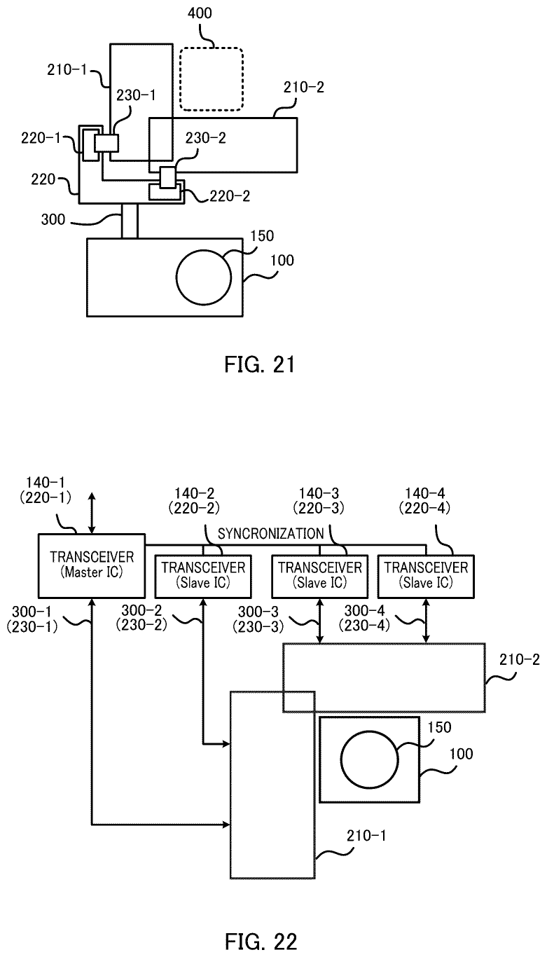

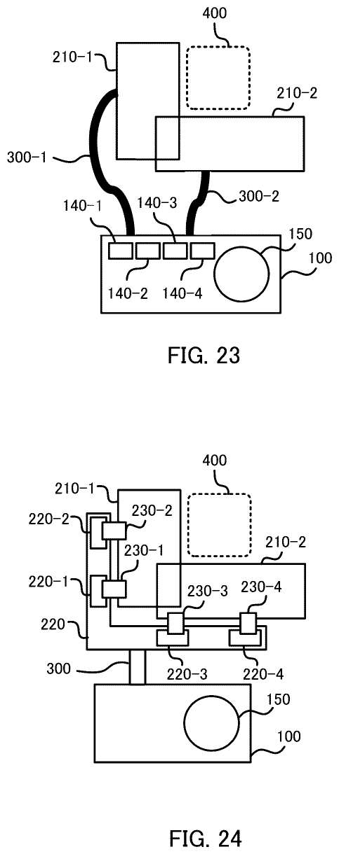

Alternatively, in antenna section 200, an electrode (for example, an antenna and a power supply line) may be wired in a region (antenna installation region) on the left side (or right side) whose horizontal direction (first direction) does not match with respect to electrode non-installation region 400 (region 400 in which the electrode is not wired), and in a region (antenna installation region) on the lower side (for example, a region whose vertical direction (second direction) is different) with respect to electrode non-installation region 400 (for example, see FIGS. 19 to 24 described below).

When antenna section 200 is configured to be installed in front of image sensor 150, the transparent electrode of antenna section 200 may shine due to the irradiation of strong light, and may cause noise in camera 150 installed behind antenna section 200. Accordingly, except in cases where antenna section 200 is configured to be installed in a location where strong light does not hit (for example, inside a vehicle cabin), the electrode of antenna section 200 is not wired in front of image sensor 150, even when the electrode is a transparent electrode.

Further, the detection accuracy of the camera and the detection accuracy of the radar are evaluated comprehensively. Accordingly, as described below, it is desirable to match an obstacle recognized by the camera with the obstacle recognized by the radar by aligning the center (or central axis, optical axis) of the camera with the center (or central axis, optical axis) of the radar.

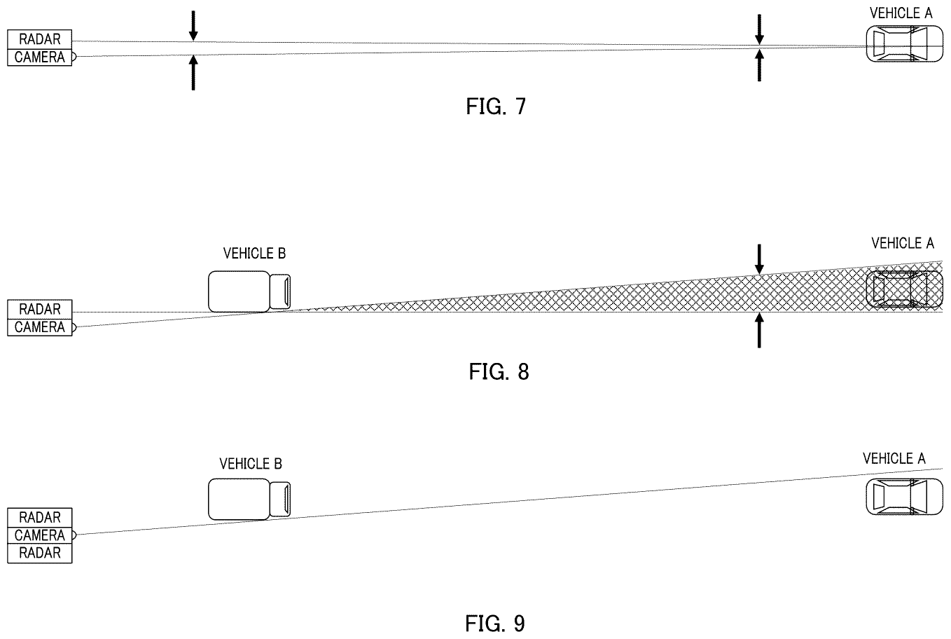

As illustrated in FIG. 7, when vehicle A (obstacle) is located at a distance, the parallax with respect to vehicle A is smaller than the deviation of the axis of the camera, and thus, the parallax does not need to be considered.

As illustrated in FIG. 8, in a case where vehicle B (another obstacle) is closer than vehicle A, when the center of the camera and the center of the radar are misaligned, there is a region that is visible from the camera but not from the radar, or a region that is visible from the radar but not from the camera. FIG. 8 illustrates an example in which there is a region that is visible from the camera but not visible from the radar because of vehicle B, and vehicle A is located in the region. For this reason, vehicle A is recognized by the camera but not by the radar.

As illustrated in FIG. 9, by matching the center of the camera with the center of the radar, it is possible to make the detection range of the camera and the detection range of the radar coincide or include overlapping portions. Vehicle A is recognizable with both the camera and the radar.

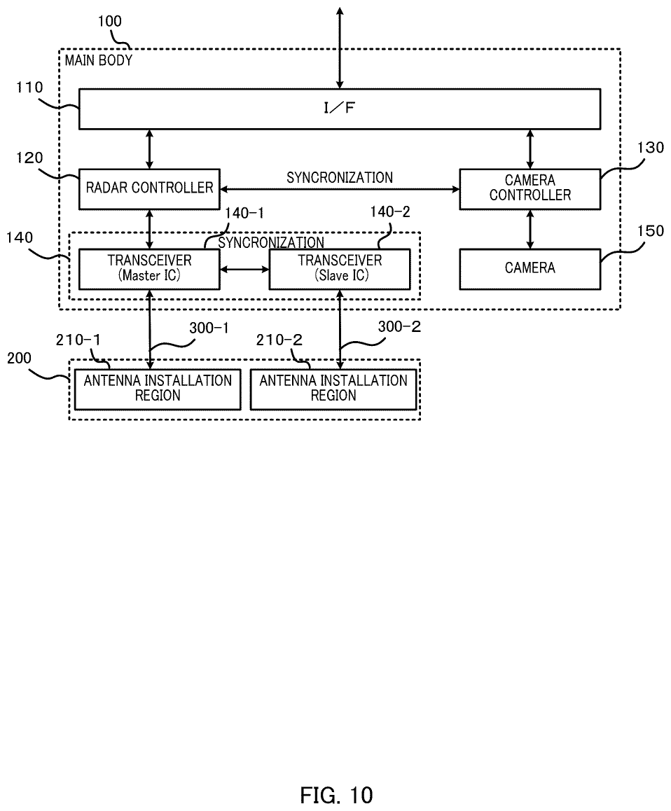

Main body 100 illustrated in FIG. 10 includes interface 110, radar controller 120, camera controller 130, transceiver 140, and image sensor 150. Transceiver 140 includes plurality of transceivers 140-1 and 140-2.

One of the plurality of transceivers 140-1 and 140-2, namely transceiver 140-1 (hereinafter referred to as “master transceiver”), operates as a master that communicates with radar controller 120, and the other transceiver, namely transceiver 140-2 (hereinafter referred to as “slave transceiver”), operates as a slave that is synchronized with master transceiver 140-1. Slave transceiver 140-2 is connected to and communicates with master transceiver 140-1.

Radar controller 120 is connected to and communicates with master transceiver 140-1. Radar controller 120 is not directly connected to slave transceiver 140-2, but is connected via master transceiver 140-1. Master transceiver 140-1 and slave transceiver 140-2 are synchronized. Each of transceivers 140-1 and 140-2 is constituted by, for example, an integrated circuit (IC).

Antenna section 200 includes a plurality of antenna installation regions 210-1 and 210-2. In correspondence with antenna installation regions 210-1 and 210-2, a plurality of transceivers 140-1 and 140-2 are respectively provided in main body 100.

Transceiver 140-1 is connected to the antenna in antenna installation region 210-1 via cable 300-1, and transceiver 140-2 is connected to the antenna in antenna installation region 210-2 via cable 300-2.

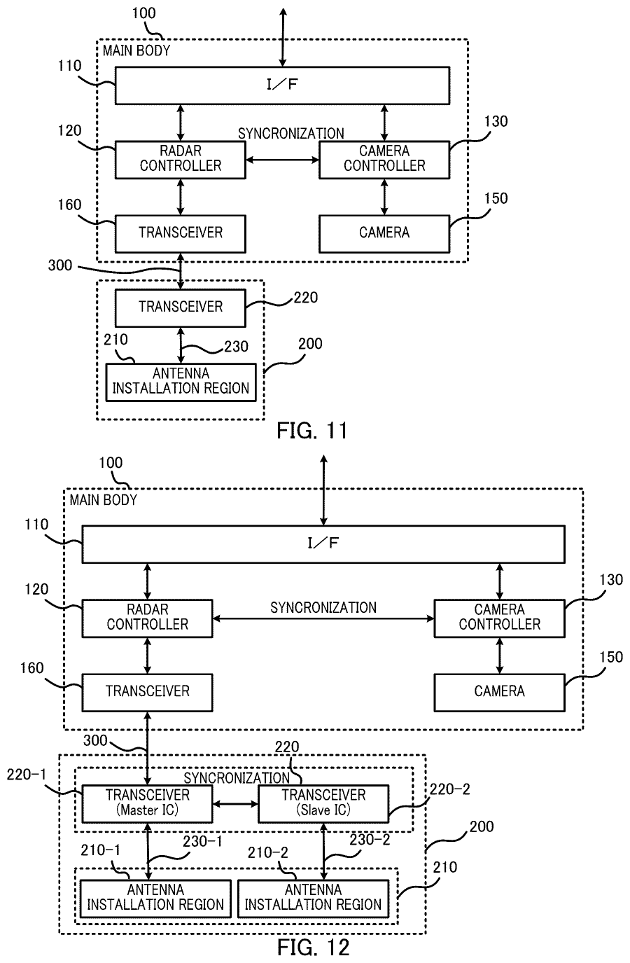

Antenna section 200 illustrated in FIG. 11 includes an antenna configured to be installed in antenna installation region 210, antenna transceiver 220, and power supply line 230. Main body 100 is substantially the same as the configuration illustrated in FIG. 10, except for transceiver 160. Transceiver 160 is connected to and communicates with antenna transceiver 220 of the antenna section. Transceiver 160 has substantially the same configuration as transceiver 140 described in FIGS. 1 and 10, but differs in that the transceiver is connected to and communicates with antenna transceiver 220 of antenna section 200.

The antenna in antenna installation region 210 is fed with power from antenna transceiver 220 via power supply line 230, and transmits received electromagnetic waves to antenna transceiver 220 via power supply line 230.

Antenna transceiver 220 communicates with transceiver 160 of the main body via cable 300.

Antenna section 200 illustrated in FIG. 12 includes antennas in a plurality of antenna installation regions 210-1 and 210-2, the plurality of antenna transceivers 220-1 and 220-2, and power supply lines 230-1 and 230-2. Main body 100 is the same as the configuration illustrated in FIG. 11, and thus, description thereof will be omitted.

One of the plurality of antenna transceivers 220-1 and 220-2, namely antenna transceiver 220-1 (hereinafter referred to as “master transceiver”), operates as a master that communicates with transceiver 160, and the other antenna transceiver, namely antenna transceiver 220-2 (hereinafter referred to as “slave transceiver”), operates as a slave that synchronizes with master antenna transceiver 220-1. Any transceiver may be used as the master transceiver.

Master antenna transceiver 220-1 and slave antenna transceiver 220-2 are synchronized. Master antenna transceiver 220-1 communicates with transceiver 160 of the main body, and slave antenna transceiver 220-2 communicates with transceiver 160 of the main body via master antenna transceiver 220-1. Transceiver 160 and antenna transceivers 220 are constituted by, for example, ICs.

The antenna in antenna installation region 210-1 is fed with power from master antenna transceiver 220-1 via power supply line 230-1, and transmits received electromagnetic waves to master antenna transceiver 220-1 via power supply line 230-1. The antenna in antenna installation region 210-2 is fed with power from slave antenna transceiver 220-2 via power supply line 230-2, and transmits received electromagnetic waves to slave antenna transceiver 220-2 via power supply line 230-2.

According to the configurations illustrated in FIGS. 10 and 12, the antenna in each of antenna installation regions 210-1 and 210-2 may be fed with power from transceiver 140 of main body 100 or may be fed with power from antenna transceivers 220-1 and 220-2 of antenna section 200.

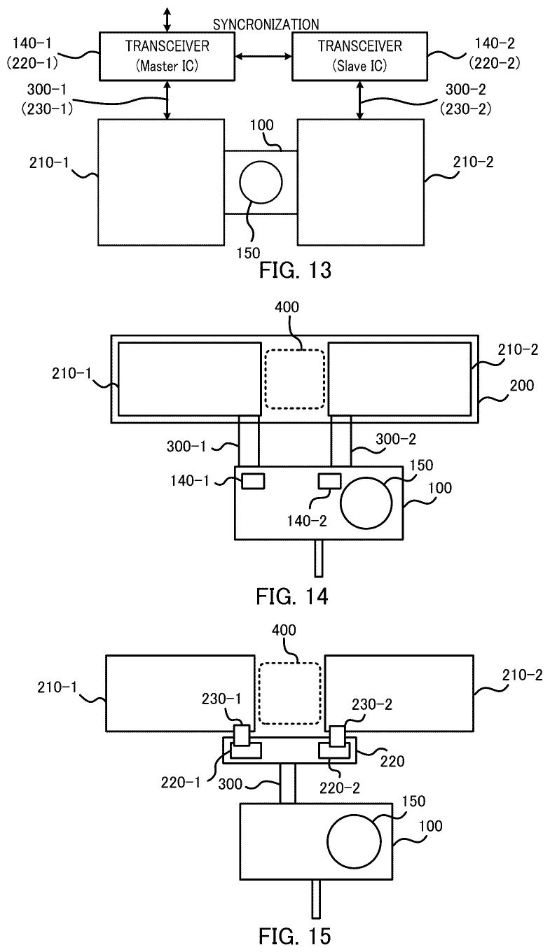

FIG. 13 illustrates an example of an arrangement of antenna installation regions 210-1 and 210-2 and camera 150 when two transceivers are used. An antenna transceiver may be used in place of the transceiver.

In this example, camera 150 is disposed between antenna installation region 210-1 and antenna installation region 210-2.

Transceiver 140-1 illustrated in FIG. 14 operates as a master and communicates with radar controller 120, while transceiver 140-2 operates as a slave. Master transceiver 140-1 and slave transceiver 140-2 are synchronized. The antenna configured to be installed in antenna installation region 210-1 is fed with power from master transceiver 140-1 via cable 300-1, and the antenna configured to be installed in antenna installation region 210-2 is fed with power from slave transceiver 140-2 via cable 300-2.

Between antenna installation regions 210-1 and 210-2, electrode non-installation region 400 is located, and main body 100 and antenna section 200 are disposed such that the field of view (FOV) of camera 150 becomes the region.

The antennas configured to be installed in antenna installation regions 210-1 and 210-2 may be fed with power from antenna transceivers 220-1 and 220-2 of antenna section 200, respectively.

Antenna transceiver 220-1 illustrated in FIG. 15 operates as a master and communicates with transceiver 160 of the main body, while antenna transceiver 220-2 operates as a slave. Master antenna transceiver 220-1 and slave antenna transceiver 220-2 are synchronized. The antenna in antenna installation region 210-1 is fed with power via power supply line 230-1 from master antenna transceiver 220-1, and the antenna in antenna installation region 210-2 is fed with power via power supply line 230-2 from slave antenna transceiver 220-2. Power supply lines 230-1 and 230-2 may be wired, such as a cable, a connector, or an FPC, or may be electromagnetically coupled.

Between antenna installation regions 210-1 and 210-2, electrode non-installation region 400 is located, and main body 100 and antenna section 200 are disposed such that the field of view (FOV) of camera 150 becomes the region.

In FIG. 15, antenna transceivers 220-1 and 220-2 are disposed on a substrate. For example, the substrate may be disposed in a location other than glass, such as a pillar or a roof of a vehicle.

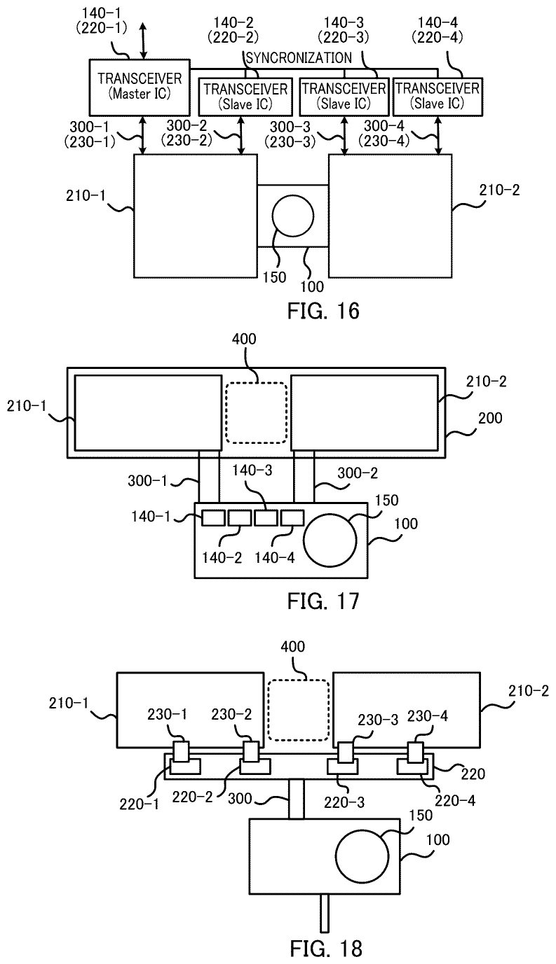

One of the four transceivers 140-1 to 140-4 illustrated in FIG. 16, namely transceiver 140-1, operates as a master, while the other transceivers 140-2 to 140-4 operate as slaves. Master transceiver 140-1 and each of slave transceivers 140-2 to 140-4 are synchronized. Master transceiver 140-1 and one of the slave transceivers, namely slave transceiver 140-2, supply power to the antenna in antenna installation region 210-1, and the other two slave transceivers 140-3 and 140-4 supply power to the antenna in antenna installation region 210-2. Camera 150 is disposed between antenna installation region 210-1 and antenna installation region 210-2. An antenna transceiver may be used in place of the transceiver.

For example, the antenna in one of the antenna installation regions (herein also simply referred to as “one antenna installation region”) 210-1 is fed with power from the master transceiver and a slave transceiver, and the antenna in the other antenna installation region 210-2 is fed with power from slave transceivers.

In FIG. 17, transceiver 140-1 operates as a master and communicates with radar controller 120, while transceivers 140-2 to 140-4 operate as slaves. Master transceiver 140-1 and slave transceivers 140-2 to 140-4 are synchronized. The antenna in antenna installation region 210-1 is fed with power from master transceiver 140-1 and slave transceiver 140-2 via cable 300-1, and the antenna in antenna installation region 210-2 is fed with power from slave transceivers 140-2 and 140-3 via cable 300-2.

Between antenna installation regions 210-1 and 210-2, electrode non-installation region 400 is located, and main body 100 and antenna section 200 are disposed such that the field of view (FOV) of camera 150 becomes the region.

The antennas in antenna installation regions 210-1 and 210-2 may be fed with power from antenna transceiver 220-1 to 220-4 of antenna section 220.

In FIG. 18, antenna transceiver 220-1 operates as a master and communicates with transceiver 160 of the main body, while antenna transceivers 220-2 to 220-4 operate as slaves. Master antenna transceiver 220-1 and slave antenna transceivers 220-2 to 220-4 are synchronized. The antenna in antenna installation region 210-1 is fed with power via power supply lines 230-1 and 230-2 from master antenna transceiver 220-1 and slave antenna transceiver 220-2, and the antenna in antenna installation region 210-2 is fed with power via power supply lines 230-3 and 230-4 from slave antenna transceivers 220-3 and 220-4. Power supply lines 230-1 to 230-4 may be wired, such as a cable, a connector, or an FPC, or may be electromagnetically coupled.

Between antenna installation regions 210-1 and 210-2, electrode non-installation region 400 is located, and main body 100 and antenna section 200 are disposed such that the field of view (FOV) of camera 150 becomes the region.

In FIG. 18, antenna transceivers 220-1 to 220-4 are disposed on a substrate. For example, the substrate may be disposed in a location other than glass, such as a pillar or a roof of a vehicle.

According to FIGS. 13 to 18, antenna installation regions 210-1 and 210-2 are disposed on both sides of camera 150, and the antennas in antenna installation regions 210-1 and 210-2 are fed with power from the transceivers via the power supply lines, respectively. Therefore, it is possible to omit the disposition of the antennas and the power supply lines in the FOV of camera 150, to shorten the line length of the power supply lines on the transparent film, to reduce the power supply loss, and to prevent the deterioration of the radar distance performance.

Further, since the antennas are disposed on both sides of the FOV of camera 150, it is possible to expand the virtual receiving antenna opening and also improve the radar angle measurement accuracy and the angle measurement resolution.

In FIGS. 19 to 24, camera 150 is disposed at a corner constituted by antenna installation regions 210-1 and 210-2 disposed in an L-shape. The configurations in FIGS. 19 to 24 are the same as those in FIGS. 13 to 18 except that the arrangement of the antennas is L-shaped, and thus the other descriptions will be omitted.

Next, a detailed configuration of antenna installation region 210 will be described. Antenna installation region 210 is constituted by one or more antenna systems 211. One or more antenna systems 211 are array antennas in which a plurality of antenna elements 212 are connected to each other by power supply line 213. Antenna system 211 may be other than an array antenna and may be constituted by one antenna element.

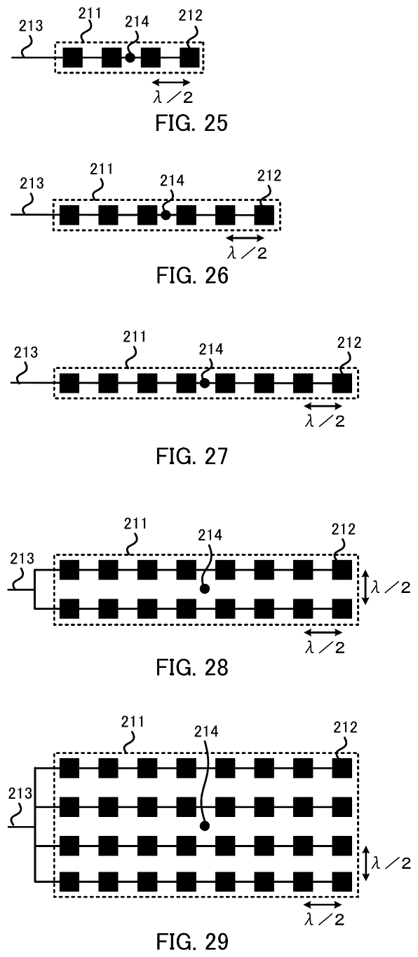

In FIGS. 25 to 29, a black square represents one antenna element (for example, a patch antenna). The more antenna elements are arranged in one antenna system, the narrower the directional beam width becomes and the higher the directional gain becomes. The number of antenna elements in each antenna system is determined so as to achieve a desired radar detection range.

Antenna elements 212 in FIGS. 25 to 29 are all disposed at intervals of ½ of the wavelength λ (hereinafter, referred to as “λ/2”) at the frequency (or the center frequency) of the electromagnetic wave to be transmitted and received. Antenna elements 212 may be arranged in one row or in a plurality of rows.

When antenna systems 211 are configured to be mounted on a vehicle, antenna systems 211 are mounted such that, for example, antenna elements 212 are disposed in the up-down direction of the vehicle in order to narrow the directional beam width in the vertical direction.

The phase center of each antenna system 211 in FIGS. 25 to 29 is indicated by 214. The distance between antenna systems 211 is determined by the distance between phase centers 214.

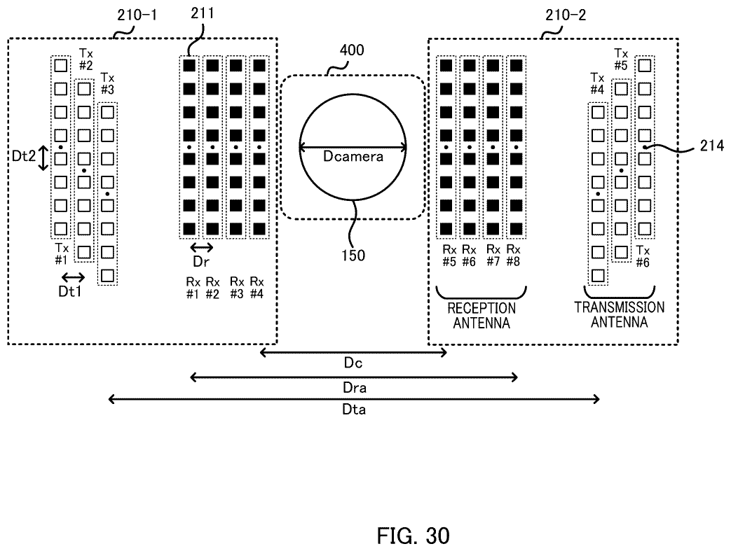

As an example of the arrangement of antenna systems (hereinafter, also simply referred to as “antenna”) constituting the MIMO antenna, FIG. 30 illustrates an example of the arrangement of antenna elements in each antenna installation region 210, where three antenna systems 211 each composed of eight elements are arranged as transmitting antennas, and four antenna systems 211 each composed of eight elements are arranged as receiving antennas. In the following figures, each transmitting antenna is illustrated with an antenna element in the transmitting antenna represented by a white square, and each receiving antenna is illustrated with an antenna element in the receiving antenna represented by a black square.

For example, the antenna in antenna installation region 210-1 is fed with power from master transceiver 140-1 illustrated in FIG. 10, and the antenna in antenna installation region 210-2 is fed with power from slave transceiver 140-2 illustrated in FIG. 10. Alternatively, the antenna in antenna installation region 210-1 is fed with power from master antenna transceiver 220-1 illustrated in FIG. 12, and the antenna in antenna installation region 210-2 is fed with power from slave antenna transceiver 220-2 illustrated in FIG. 12.

FIG. 30 and subsequent figures each describe an example in which an array antenna with eight elements is used as antenna system 211, but antenna system 211 may have another configuration.

In the example of FIG. 30, receiving antenna system 211 (hereinafter, simply referred to as “receiving antenna”) is disposed in a region close to camera 150, and transmitting antenna system 211 (hereinafter, simply referred to as “transmitting antenna”) is disposed in a region far from camera 150. Each transmitting antenna transmits a radar transmission wave (for example, a chirp signal or a pulse compression wave). Further, radar transmission waves may be transmitted in a time-division manner from each transmitting antenna at a predetermined time period, or radar transmission waves may be simultaneously multiplexed and transmitted using Doppler multiplexing or code multiplexing.

The receiving antennas are arranged at interval Dr in the first direction (horizontal direction), and the transmitting antennas are offset by Dt2 in the second direction (vertical direction) orthogonal to the first direction and are arranged at interval Dt1 in the first direction.

The distance between the receiving antennas disposed at the locations farthest from camera 150 in respective antennas is defined as Dra. Further, the distance between the transmitting antennas disposed at the locations closest to camera 150 in respective antennas is defined as Dta.

The transmitting antennas (Tx #1 and Tx #6) disposed at the locations farthest from camera 150 have no offset in the second direction, and the transmitting antennas disposed at the locations closer to camera 150 have larger offsets in the second direction.

Here, the length of the FOV of camera 150 in the first direction is defined as Dcamera, and the distance between the receiving antennas (Rx #4 and Rx #5) disposed at the locations closest to camera 150 in the antennas is defined as Dc. In this case, by satisfying Dc>Dcamera, it is possible to avoid disposing antenna element 212 in the FOV of camera 150.

Another offset may be given to the transmitting antenna.

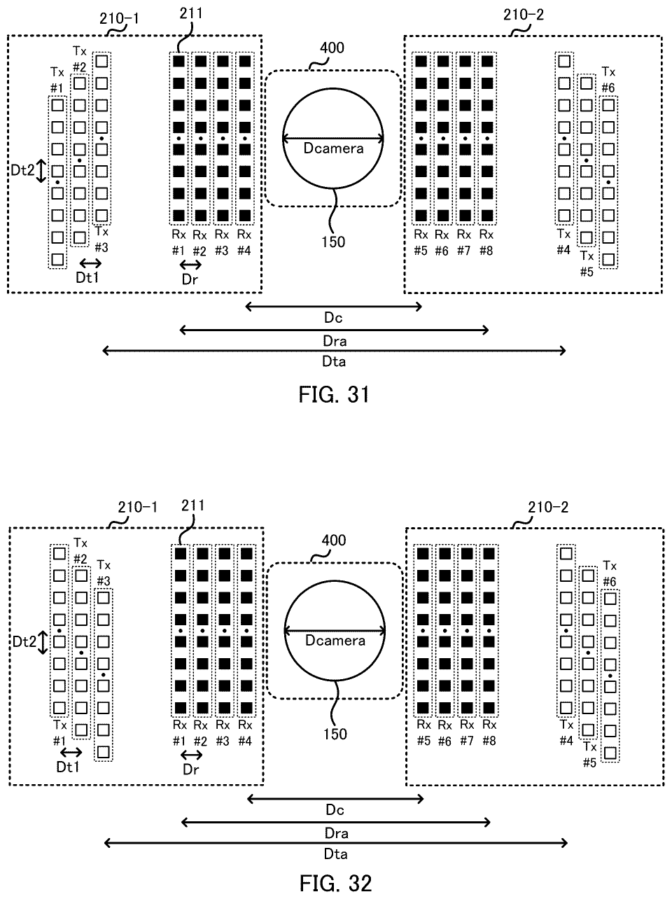

In FIG. 31, the transmitting antennas (Tx #3 and Tx #4) disposed at the closest locations to camera 150 have no offset in the second direction, and a transmitting antenna disposed at a location farther from camera 150 have a larger offset in the second direction.

In FIG. 32, in one antenna installation region 210-1, transmitting antenna (Tx #1) disposed at a location farthest from camera 150 has no offset in the second direction, and a transmitting antenna disposed at a location closer to camera 150 has a larger offset in the second direction.

In the other antenna installation region 210-2, the transmitting antenna (Tx #4) disposed at the location closest to camera 150 has no offset in the second direction, and a transmitting antenna disposed at a location farther from camera 150 has a larger offset in the second direction.

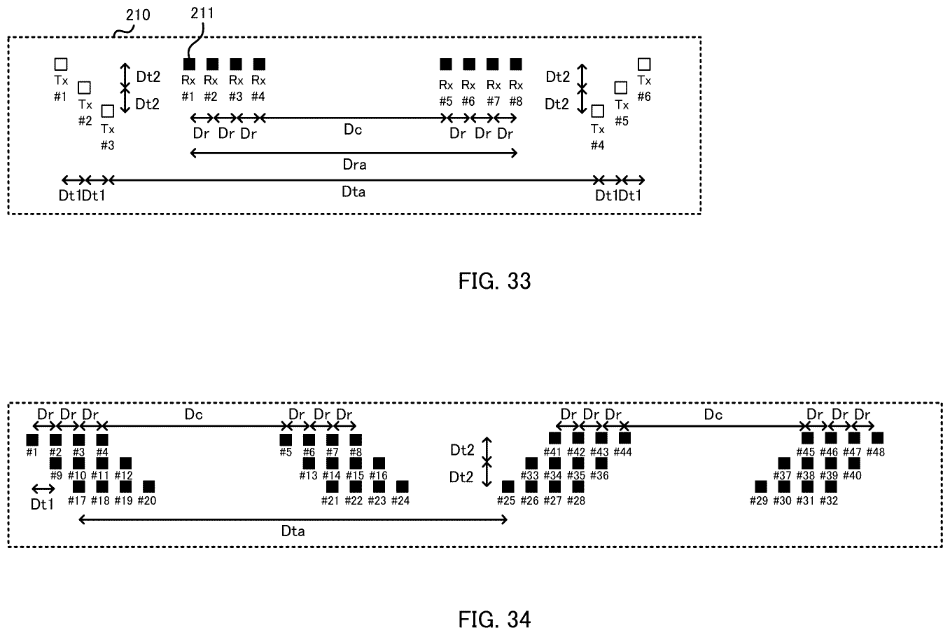

FIG. 33 illustrates the antenna arrangement of FIG. 30 in a simplified manner by representing each of the transmitting antennas and the receiving antennas with a phase center. Dt1, Dt2, and Dr are all equal, for example, λ/2. Then, for example, Dc is 8.5λ, Dra is 11.5λ, and Dta is 14.5λ. Dc, Dra, and Dta may be other values.

FIG. 34 is a virtual receiving antenna arrangement corresponding to the opening antennas in FIG. 33.

In FIG. 34, virtual antennas (VAs) in a case where Tx #1 transmits electromagnetic waves and Rx #1 to Rx #8 receive the electromagnetic waves are VA #1 to VA #8. Further, virtual antennas in a case where Tx #2 transmits electromagnetic waves and Rx #1 to Rx #8 receive the electromagnetic waves are VA #9 to VA #16. Further, virtual antennas in a case where Tx #3 transmits electromagnetic waves and Rx #1 to Rx #8 receive the electromagnetic waves are VA #17 to VA #24.

In addition, virtual antennas in a case where Tx #4 transmits electromagnetic waves and Rx #1 to Rx #8 receive the electromagnetic waves are VA #25 to VA #32. Further, virtual antennas in a case where Tx #5 transmits electromagnetic waves and Rx #1 to Rx #8 receive the electromagnetic waves are VA #33 to VA #40. Further, virtual antennas in a case where Tx #6 transmits electromagnetic waves and Rx #1 to Rx #8 receive the electromagnetic waves are VA #41 to VA #48.

Accordingly, the distance between VA #1 and VA #2 in the first direction is Dr, the distance between VA #4 and VA #5 in the first direction is Dc, and the distance between VA #17 and VA #25 in the first direction is Dta. Further, the distance between VA #1 and VA #9 in the first direction is Dt1, and the distance between VA #1 and VA #9 in the second direction is Dt2.

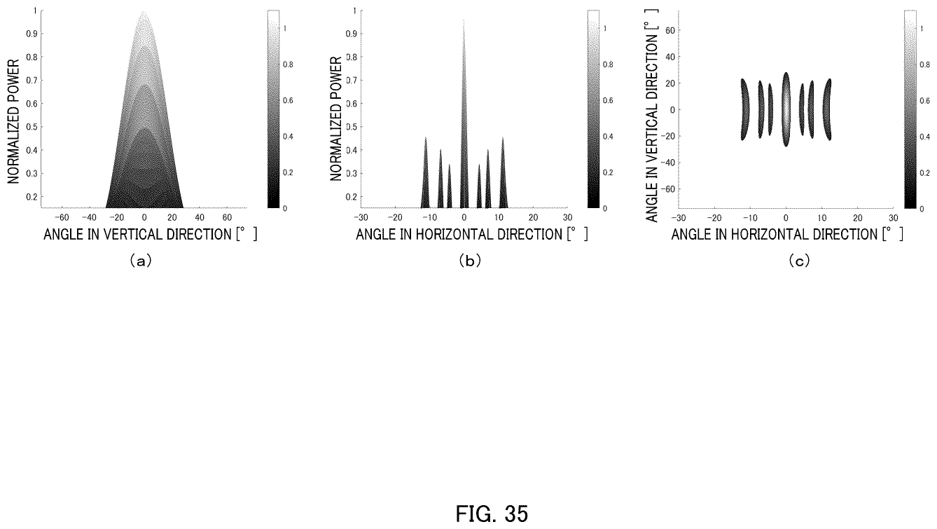

FIG. 35 illustrates the simulated angle measurement results (Fourier beamformer method) in a case where each antenna element is disposed according to FIG. 33, where part (a) in FIG. 35 illustrates power with respect to the vertical angle, part (b) in FIG. 35 illustrates power with respect to the horizontal angle, and part (c) in FIG. 35 illustrates the power corresponding to the horizontal direction and the vertical direction. According to the measurement results, from parts (a) and (b) in FIG. 35, a main lobe with a reception power peak in the target object true value direction (horizontal 0 degrees and vertical 0 degrees) is detected, and from part (c) in FIG. 35, the beam width in the vertical direction is approximately 36 degrees and the beam width in the horizontal direction is approximately 2 degrees.

Even when electrode non-installation region 400 (FOV region of camera 150) is located between the antennas, the grating lobe can be suppressed by arranging antenna systems 211 of the receiving antenna in the horizontal direction at intervals of Dr (for example, λ/2). Further, since the aperture length of the MIMO virtual receiving antenna can be expanded in the horizontal direction, the radar angle measurement performance can be improved, specifically, the angle measurement accuracy and resolution in the horizontal direction can be enhanced.

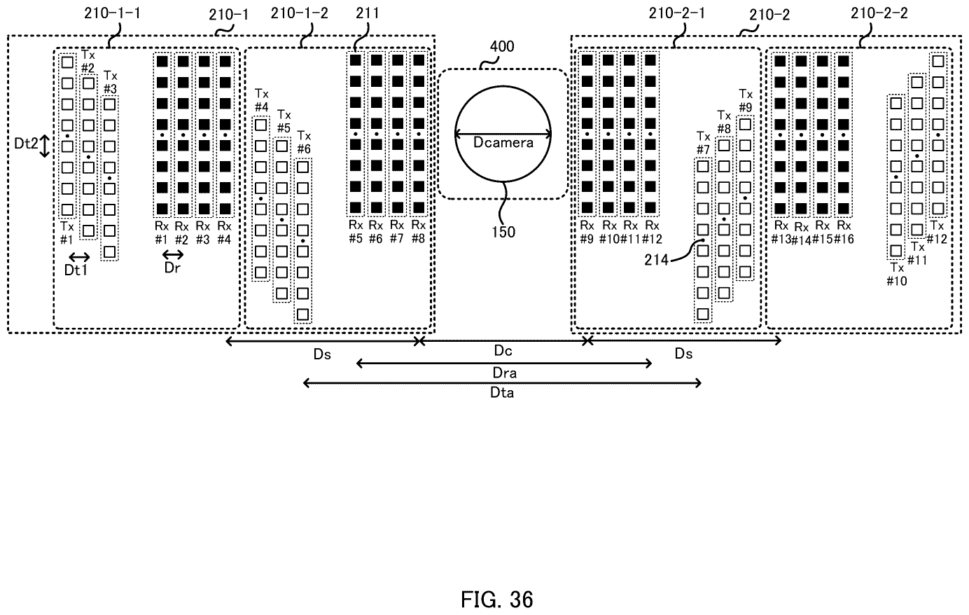

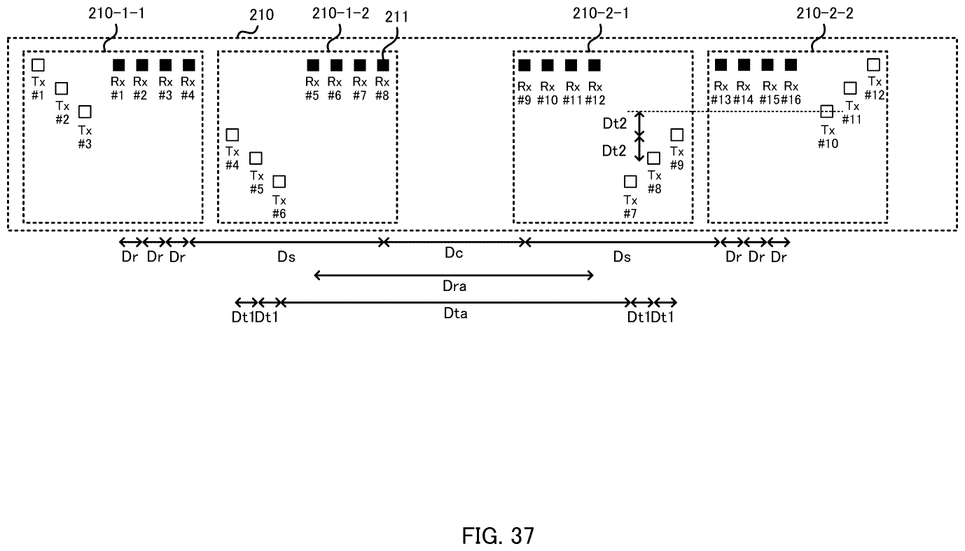

FIG. 36 is an example of an arrangement of antennas fed with power from four transceivers, and FIG. 37 illustrates the antenna arrangement of FIG. 36 in a simplified manner.

FIG. 37 illustrates an example as follows: antenna installation regions 210-1 and 210-2 each include two antenna installation regions, for example, antenna installation region 210-1-1 or 210-2-2 (hereinafter, referred to as “far region”) far from the camera, and antenna installation region 210-1-2 or 210-2-1 (hereinafter, referred to as “near region”) close to the camera; and in each antenna installation region, three transmitting antennas are disposed in a portion far from camera 150, and four receiving antennas are disposed in a portion close to camera 150.

Here, the transmitting antenna and the receiving antenna in far region 210-1-1 are fed with power from master transceiver 140-1 illustrated in FIG. 16, and the transmitting antenna and the receiving antenna in near region 210-1-2 are fed with power from slave transceiver 140-2 illustrated in FIG. 16.

Further, the transmitting antenna and the receiving antenna in near region 210-2-1 are fed with power from slave transceiver 140-3 illustrated in FIG. 16, and the transmitting antenna and the receiving antenna in far region 210-2-2 are fed with power from slave transceiver 140-4 illustrated in FIG. 16.

Each antenna may have three or more antenna regions, and the transmitting antennas and the receiving antennas in the plurality of antenna regions may be fed with power from one transceiver. Further, the transmission antennas and the receiving antennas may be fed with power from antenna transceiver 220 of the antenna section.

Further, four receiving antennas are disposed at positions closer to camera 150 in each near region and each far region, and a transmitting antenna is disposed at a position farther from camera 150. In such a case, when the length of the FOV of camera 150 in the first direction is Dcamera, and the distance between the receiving antennas (Rx #8 and Rx #9) closest to camera 150 in the respective near regions is Dc, it is possible to avoid disposing antenna element 212 in the FOV of camera 150 by setting Dc>Dcamera.

Here, the distance between receiving antennas (Rx #5 and Rx #12) disposed at the locations farthest from camera 150 in the respective near regions is defined as Dra, and the distance between transmitting antennas (Tx #6 and Tx #7) disposed at the locations closest to camera 150 in the respective near regions is defined as Dta.

Further, the distance between far region 210-1-1 and near region 210-1-2, and the distance between near region 210-2-1 and far region 210-2-2 are both defined as Ds.

The transmitting antennas in each far region are offset by Dt2 in the second direction and are arranged at intervals of Dt1 in the first direction. The transmitting antennas (Tx #1 and Tx #12) that are disposed at the locations farthest from camera 150 have no offset in the second direction, while a transmitting antenna system that is disposed at a location closer to camera 150 has a larger offset in the second direction.

The transmitting antennas in each near region are offset by Dt2 in the second direction and are arranged at interval Dt1 in the first direction. Transmitting antennas (Tx #4 and Tx #9) disposed at the locations farthest from camera 150 in the respective near regions are further offset in the second direction by Dt2 with respect to transmitting antennas (Tx #3 and Tx #10) disposed at the locations closest to camera 150 in the far regions of the same antennas. A transmitting antenna in each near region has a larger offset in the second direction as the transmitting antenna is disposed closer to camera 150.

The receiving antennas in each antenna region are arranged at interval Dr in the first direction.

The arrangements of the transmitting antennas and the receiving antennas in near regions 210-1-2 and 210-2-1 are the same as the arrangements of the transmitting antennas and the receiving antennas in far regions 210-1-1 and 210-2-2 in the first direction of the antennas, but the arrangements of the transmitting antenna in the second direction are different.

Further, Dt1, Dt2, and Dr are all λ/2. Then, for example, Dc is 11λ, Dra is 14λ, Dta is 17λ, and Ds is 5.5λ. Dc, Dra, Dta, and Ds may be other values.

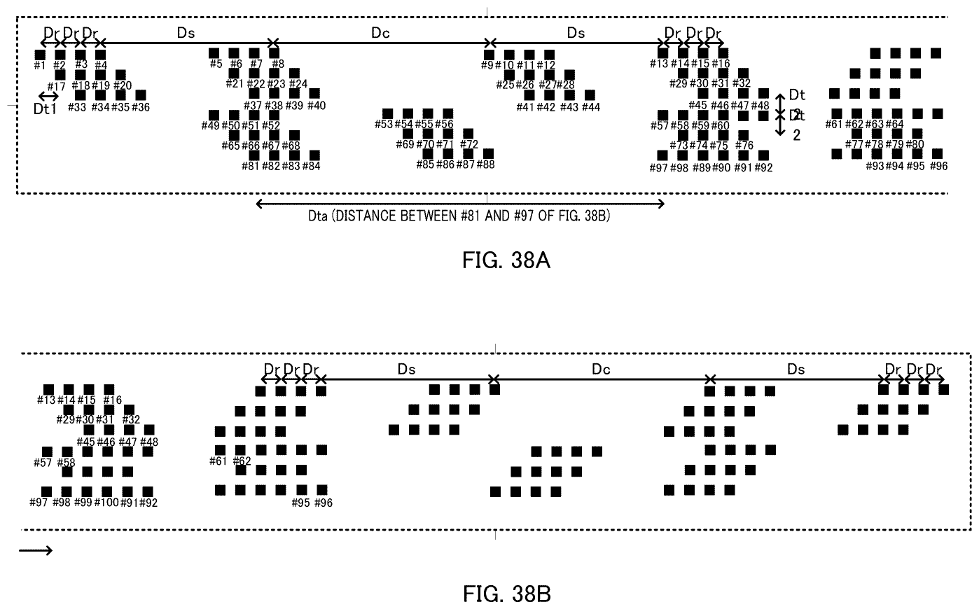

FIGS. 38A and 38B are virtual receiving antenna arrangements corresponding to the opening antennas in FIG. 37. In FIG. 38A, the virtual receiving antennas corresponding to Tx #1 to Tx #6 are illustrated in a dark color, and in FIG. 38B, the virtual receiving antennas related to Tx #7 to Tx #12 are illustrated in a dark color.

The position indicated by a light-colored square in FIG. 38A indicates the position of a virtual antenna indicated by a dark-colored square in FIG. 38B, and the position indicated by a light-colored square in FIG. 38B indicates the position of a virtual antenna indicated by a dark-colored square in FIG. 38A. FIG. 38B can be understood in the same manner as FIG. 38A, and thus, numbers are assigned to the four virtual receiving antennas in the lower left.

In FIGS. 38A and 38B, virtual antennas in a case where Tx #1 transmits electromagnetic waves and Rx #1 to Rx #16 receive the electromagnetic waves are VA #1 to VA #16. Further, virtual antennas in a case where Tx #2 transmits electromagnetic waves and Rx #1 to Rx #16 receive the electromagnetic waves are VA #17 to VA #32. Further, virtual antennas in a case where Tx #3 transmits electromagnetic waves and Rx #1 to Rx #16 receive the electromagnetic waves are VA #33 to VA #48.

In addition, virtual antennas in a case where Tx #4 transmits electromagnetic waves and Rx #1 to Rx #16 receive the electromagnetic waves are VA #49 to VA #64. Further, virtual antennas in a case where Tx #5 transmits electromagnetic waves and Rx #1 to Rx #16 receive the electromagnetic waves are VA #65 to VA #80. Further, virtual antennas in a case where Tx #6 transmits electromagnetic waves and Rx #1 to Rx #16 receive the electromagnetic waves are VA #81 to VA #96.

Accordingly, the distance between VA #1 and VA #2 in the first direction is Dr, the distance between VA #4 and VA #8 in the first direction is Ds, the distance between VA #8 and VA #9 in the first direction is Dc, and the distance between VA #9 and VA #13 in the first direction is Ds. The distance between VA #1 and VA #17 in the first direction is Dt1, and the distance between VA #1 and VA #17 in the second direction is Dt2.

Further, virtual antennas in a case where Tx #7 transmits electromagnetic waves and Rx #1 to Rx #4 receive the electromagnetic waves are VA #97 to VA #100. Then, the distance between VA #81 and VA #97 in the first direction is Dta.

The virtual receiving antennas in FIG. 38A may be in the same positions as those of the virtual receiving antennas in FIG. 38B. For example, when Dt1, Dt2, and Dr are all λ/2, Dc is 11λ, Dra is 14λ, Dta is 17λ, and Ds is 5.5λ, VA #99 is located at the same position as VA #89, and VA #100 is located at the same position as VA #90.

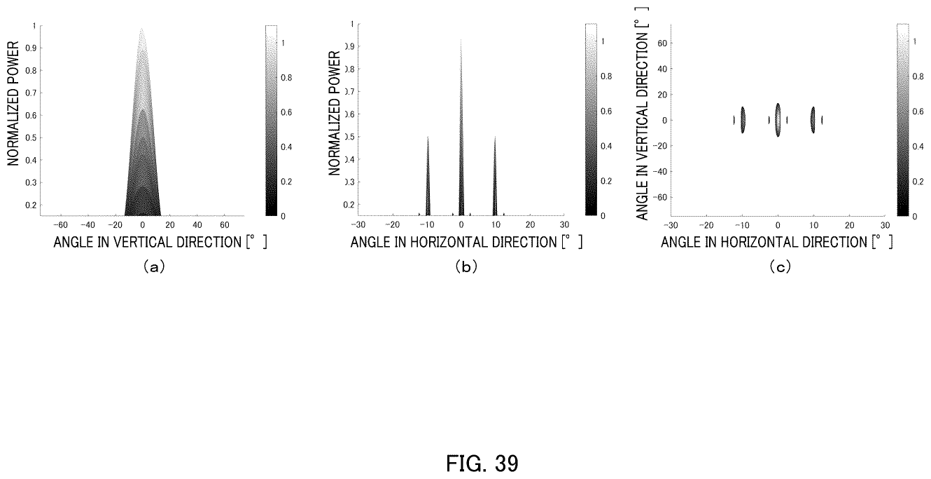

FIG. 39 illustrates the simulated angle measurement results (Fourier beamformer method) in a case where each antenna element is disposed according to FIG. 37, where part (a) in FIG. 39 illustrates power with respect to the vertical angle, part (b) in FIG. 39 illustrates power with respect to the horizontal angle, and part (c) in FIG. 39 illustrates the power corresponding to the horizontal direction and the vertical direction. From parts (a) and (b) in FIG. 39, a main lobe with a reception power peak in the target object true value direction (horizontal 0 degrees and vertical 0 degrees) is detected, and from part (c) in FIG. 39, the beam width in the vertical direction is approximately 17 degrees and the beam width in the horizontal direction is approximately 1 degree.

Even when electrode non-installation region 400 (FOV region of camera 150) is located between the antennas, the grating lobe can be suppressed by arranging antenna systems 211 of the receiving antenna in the horizontal direction at intervals of Dr (for example, λ/2).

Further, by disposing the transmitting antennas in each transmitting antenna with all different offsets, the aperture length of the MIMO virtual receiving antenna can be expanded in the horizontal direction and the vertical direction, and thus, the radar angle measurement performance, specifically, the angle measurement accuracy and the resolution in the horizontal direction and the vertical direction can be enhanced.

The offset of the transmitting antennas in each antenna region may be another offset. In each antenna, a transmitting antenna that is farther from the camera may have a larger offset in the second direction. Alternatively, for the antennas in one antenna installation region 210-1, a transmitting antenna that is farther from the camera may have a larger offset in the second direction, and for the antennas in the other antenna installation region 210-2, a transmitting antenna that is closer to the camera may have a larger offset in the second direction. For the offsets of the transmitting antennas, refer to FIGS. 31 to 33.

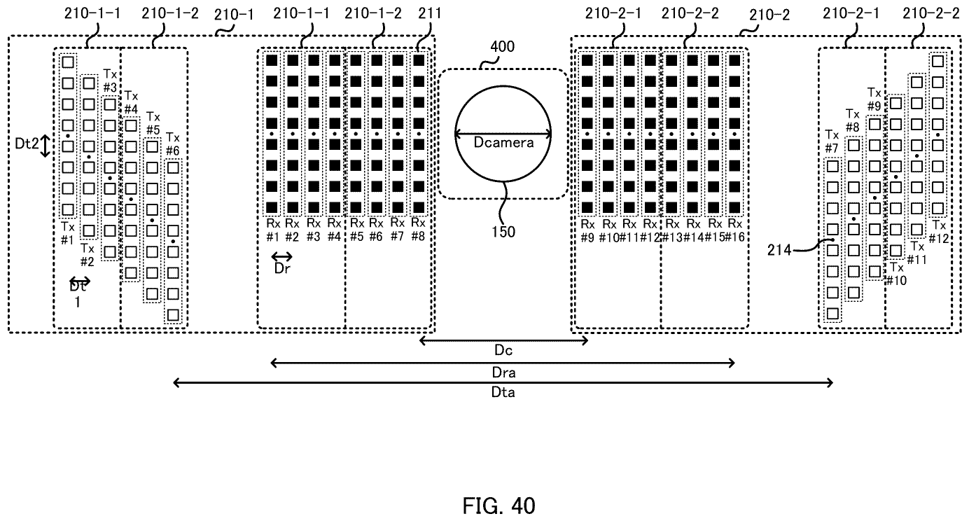

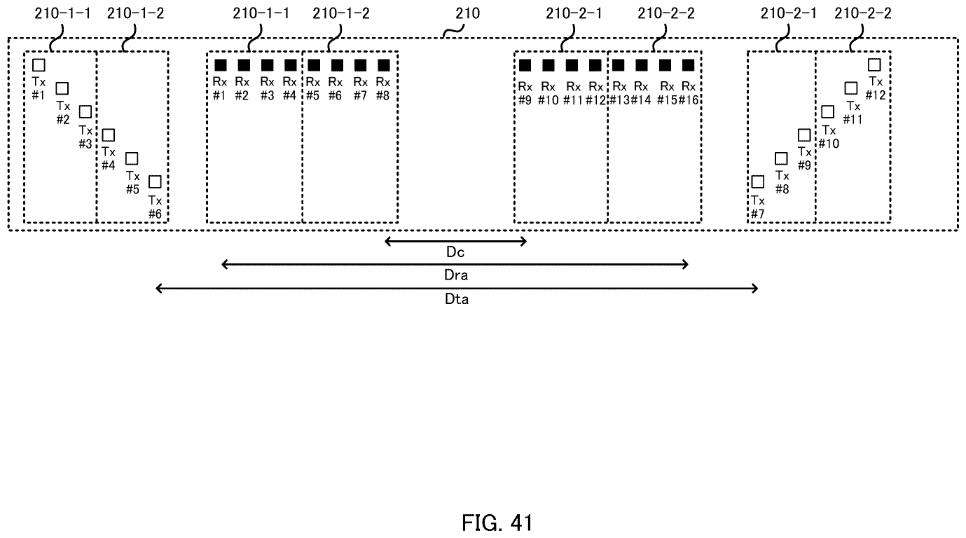

FIG. 40 illustrates an example in which, in each antenna installation region 210, six 1×8-element transmitting antennas are disposed in a region far from the camera and eight 1×8-element receiving antennas are disposed in a region close to the camera. FIG. 41 illustrates the antenna arrangement of FIG. 40 in a simplified manner.

In one antenna installation region 210-1, three transmitting antennas (Tx #1 to Tx #3) of the six transmitting antennas (the three transmitting antennas are far from camera 150), and four receiving antennas (Rx #1 to Rx #4) of the eight transmitting antennas (the four transmitting antennas are far from camera 150) constitute one antenna installation region 210-1-1. Those antennas constituting one antenna installation region 210-1-1 are fed with power from master transceiver 140-1 illustrated in FIG. 16.

In one antenna installation region 210-1, three transmitting antennas (Tx #4 to Tx #6) of the six transmitting antennas (the three transmitting antennas are close to camera 150), and four receiving antennas (Rx #5 to Rx #8) of the eight transmitting antennas (the four transmitting antennas are close to camera 150) constitute another antenna installation region 210-1-2. Those antennas constituting the other antenna installation region 210-1-2 are fed with power from slave transceiver 140-2 illustrated in FIG. 16.

In the other antenna installation region 210-2, three transmitting antennas (Tx #7 to Tx #9) of the six transmitting antennas (the three transmitting antennas are close to camera 150), and four receiving antennas (Rx #9 to Rx #12) of the eight transmitting antennas (the four transmitting antennas are close to camera 150) constitute one antenna installation region 210-2-1. Those antennas constituting one antenna installation region 210-2-1 are fed with power from slave transceiver 140-3 illustrated in FIG. 16.

In the other antenna installation region 210-2, three transmitting antennas (Tx #10 to Tx #12) of the six transmitting antennas (the three transmitting antennas are far from camera 150), and four receiving antennas (Rx #13 to Rx #16) of the eight transmitting antennas (the four transmitting antennas are far from camera 150) constitute another antenna installation region 210-1-2. Those antennas constituting the other antenna installation region 210-1-2 are fed with power from slave transceiver 140-4 illustrated in FIG. 16.

Further, each antenna may be fed with power from three or more transceivers.

Here, the length of the FOV of camera 150 in the first direction is defined as Dcamera, and the distance between the receiving antennas (Rx #8 and Rx #9 in respective antennas) closest to the camera is defined as Dc. In this case, by setting Dc>Dcamera, it is possible to avoid disposing antenna element 212 in the FOV of camera 150.

Further, the distance between receiving antennas (Rx #1 and Rx #16) disposed at the locations farthest from camera 150 is defined as Dra, and the distance between transmitting antennas (Tx #6 and Tx #7) disposed at the locations closest to camera 150 is defined as Dta. In this case, the antenna arrangement is such that Dc>Dcamera and Dta>Dra.

Further, the transmitting antennas of each antenna are offset by Dt2 in the second direction and are arranged at interval Dt1 in the first direction. In the respective antennas, transmitting antennas disposed at locations farthest from camera 150 (Tx #1 and Tx #12) have no offset in the second direction, and a transmitting antenna disposed at a location closer to camera 150 has a larger offset in the second direction.

Further, the receiving antennas of each antenna are arranged at interval Dr in the first direction.

Dt1, Dt2, and Dr are all λ/2. Then, for example, Dc is 11λ, Dra is 18λ, and Dta is 25λ. Dc, Dra, and Dta may be other values.

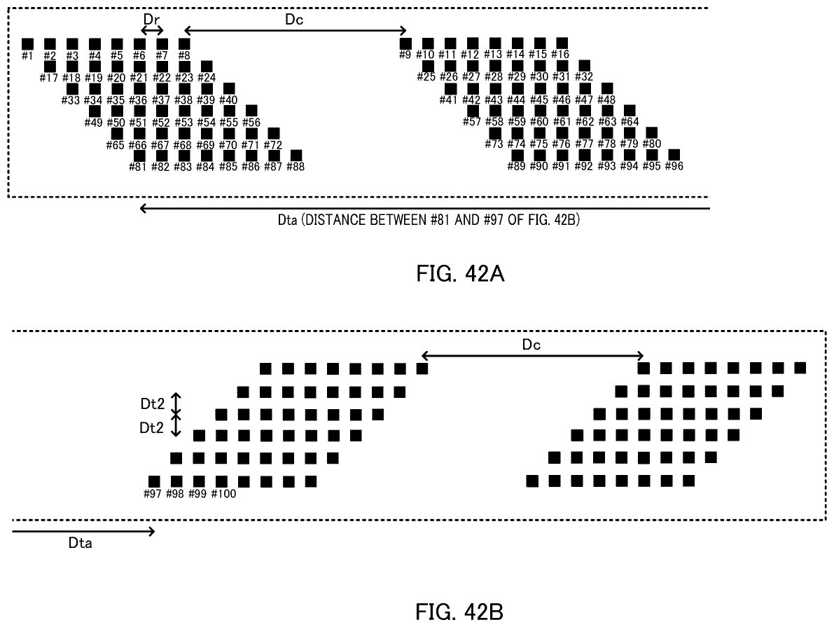

FIGS. 42A and 42B illustrate a virtual receiving antenna arrangement of the opening antennas in FIG. 41. FIGS. 42A and 42B can be understood in the same manner as FIGS. 38A and 38B. The virtual receiving antennas in FIG. 42A may be in the same positions as those of the virtual receiving antennas in FIG. 42B.

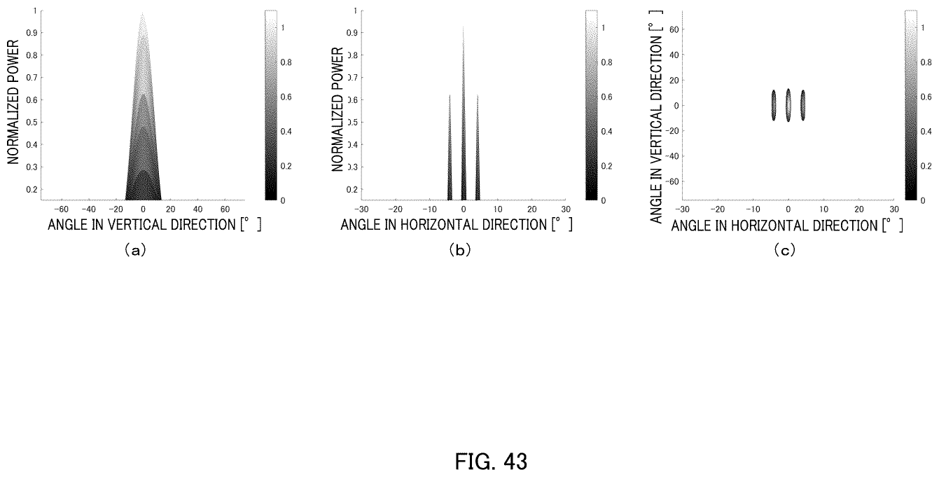

FIG. 43 illustrates the simulated angle measurement results (Fourier beamformer method) in a case where each antenna element is disposed according to FIG. 41. Part (a) in FIG. 43 illustrates power with respect to the vertical angle, part (b) in FIG. 43 illustrates power with respect to the horizontal angle, and part (c) in FIG. 43 illustrates power corresponding to the horizontal direction and the vertical direction. From parts (a) and (b) in FIG. 43, a main lobe with a reception power peak in the target object true value direction (horizontal 0 degrees and vertical 0 degrees) is detected, and from part (c) in FIG. 43, the beam width in the vertical direction is approximately 28 degrees, and the beam width in the horizontal direction is approximately 2 degrees.

Even when electrode non-installation region 400 (FOV region of camera 150) is located between the antennas, the grating lobes can be suppressed by arranging antenna systems 211 of the receiving antennas of each antenna in the horizontal direction at intervals of Dr (for example, λ/2).

Further, since the aperture length of the MIMO virtual receiving antenna can be expanded in the horizontal direction, it is possible to enhance the radar angle measurement performance, specifically, the angle measurement accuracy and resolution in the horizontal direction.

The offset of the transmitting antenna in each antenna region may be another offset. In the transmitting antennas of each antenna, a transmitting antenna farther from the camera may have a larger offset in the second direction.

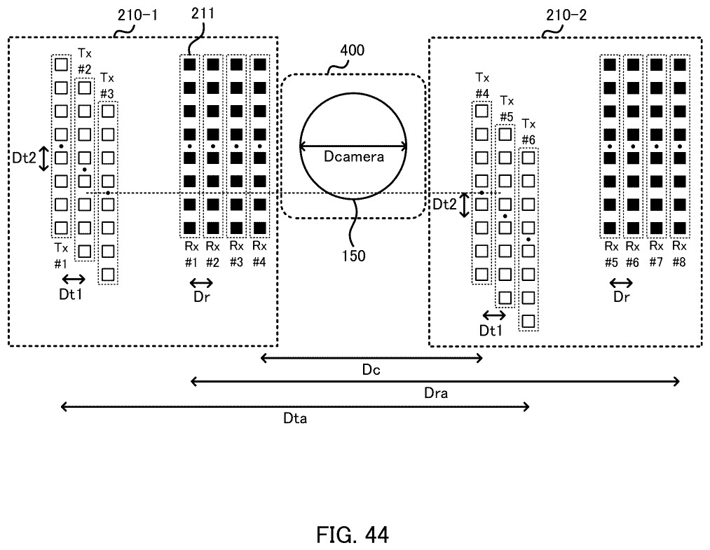

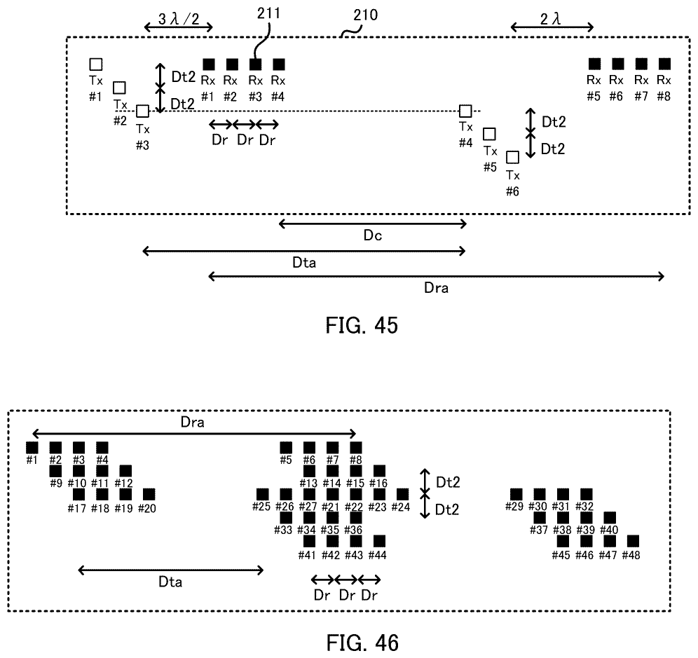

In FIGS. 44 and 45, in one antenna installation region 210-1, four receiving antennas (Rx #1 to Rx #4) are disposed in a region close to camera 150, and three transmitting antennas (Tx #1 to Tx #3) are disposed in a region far from camera 150. In the other antenna installation region 210-2, three transmitting antennas (Tx #4 to Tx #6) are disposed in a region close to camera 150, and four receiving antennas (Rx #5 to Rx #8) are disposed in a region far from camera 150.

In each antenna, the receiving antennas are arranged at interval Dr in the first direction, and the transmitting antennas are offset by Dt2 in the second direction orthogonal to the first direction and are arranged at interval Dt1 in the first direction.

The transmitting antenna (Tx #1) disposed at the location farthest from camera 150 in one antenna installation region 210-1 has no offset in the second direction, and a transmitting antenna disposed at a location closer to camera 150 has a larger offset in the second direction.

Transmitting antenna (Tx #4) disposed at a location closest to camera 150 in the other antenna installation region 210-2 has the same offset as transmitting antenna (Tx #3) having the largest offset in one antenna installation region 210-1, and a transmitting antenna disposed at a location farther from camera 150 in the other antenna installation region 210-2 has a larger offset in the second direction.

Here, the length of the FOV of camera 150 in the first direction is defined as Dcamera. Further, the distance between the transmitting antenna and the receiving antenna in the respective antennas, which are disposed at locations closest to camera 150, for example, the distance between the receiving antenna (Rx #4) disposed at a location closest to camera 150 in one antenna installation region 210-1 and the transmitting antenna (Tx #4) disposed at a location closest to camera 150 in the other antenna installation region 210-2 is defined as Dc.

In this case, by setting Dc>Dcamera, it is possible to avoid disposing antenna element 212 in the FOV of camera 150.

Further, the distance between receiving antennas (Rx #1 and Rx #8) disposed at the locations farthest from camera 150 in the respective antennas is defined as Dra, and the distance between transmitting antennas (Tx #3 and Tx #4) disposed at the locations closest to camera 150 in the respective antennas is defined as Dta.

Here, Dt1, Dt2, and Dr are all λ/2. Then, for example, Dc is 8.5λ, Dra is 11.5λ, and Dta is 14.5λ. In this case, the distance between Tx #3 and Rx #1 in the first direction in one antenna installation region 210-1 is 3λ/2, and the distance between Tx #6 and Rx #5 in the first direction in the other antenna installation region 210-2 is 2λ; however, those distances may be other values, and do not have to be the same value.

The horizontal direction arrangement of the transmitting antennas and the receiving antennas in one antenna does not have to be the same as the horizontal direction arrangement of the transmitting antennas and the receiving antennas in the other antenna. Further, Dc, Dra, and Dta may be other values.

FIG. 46 illustrates a virtual receiving antenna arrangement of the opening antennas in FIG. 45. FIG. 46 can be understood in the same manner as FIG. 34. In FIG. 46, VA #28 is in the same position as VA #21.

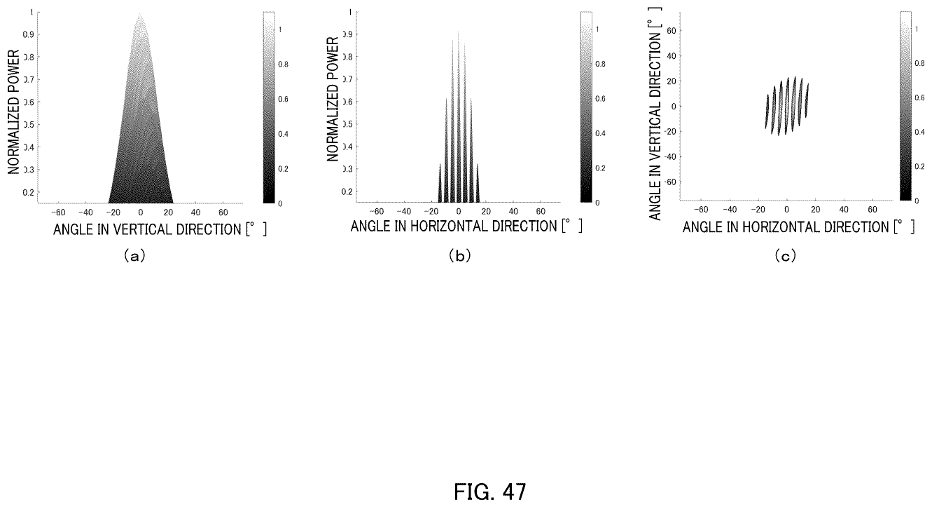

FIG. 47 illustrates the simulated angle measurement results (Fourier beamformer method) in a case where each antenna element is disposed according to FIG. 45. Part (a) in FIG. 47 illustrates power with respect to the vertical angle, part (b) in FIG. 47 illustrates power with respect to the horizontal angle, and part (c) in FIG. 47 illustrates power corresponding to the horizontal direction and the vertical direction. From parts (a) and (b) in FIG. 47, a main lobe with a reception power peak in the target object true value direction (horizontal 0 degrees and vertical 0 degrees) is detected, and from part (c) in FIG. 47, the beam width in the vertical direction is approximately 28 degrees, and the beam width in the horizontal direction is approximately 2 degrees.

Even when electrode non-installation region 400 (FOV region of camera 150) is located between the antennas, the grating lobes can be suppressed by arranging antenna systems 211 of the receiving antennas of each antenna in the horizontal direction at intervals of Dr (for example, λ/2).

Further, since the aperture length of the MIMO virtual receiving antenna can be expanded in the horizontal direction and the vertical direction, it is possible to enhance the radar angle measurement performance, specifically, the angle measurement accuracy and the resolution in the horizontal direction and the vertical direction.

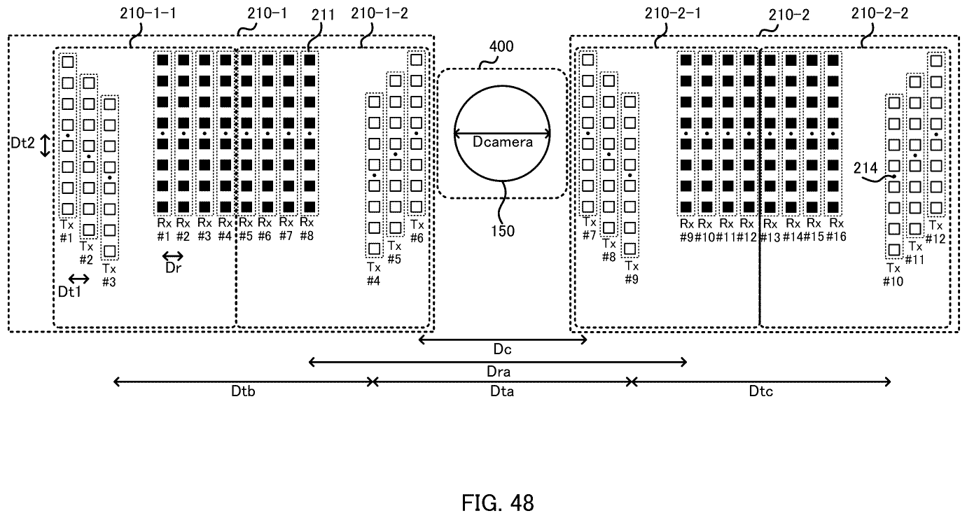

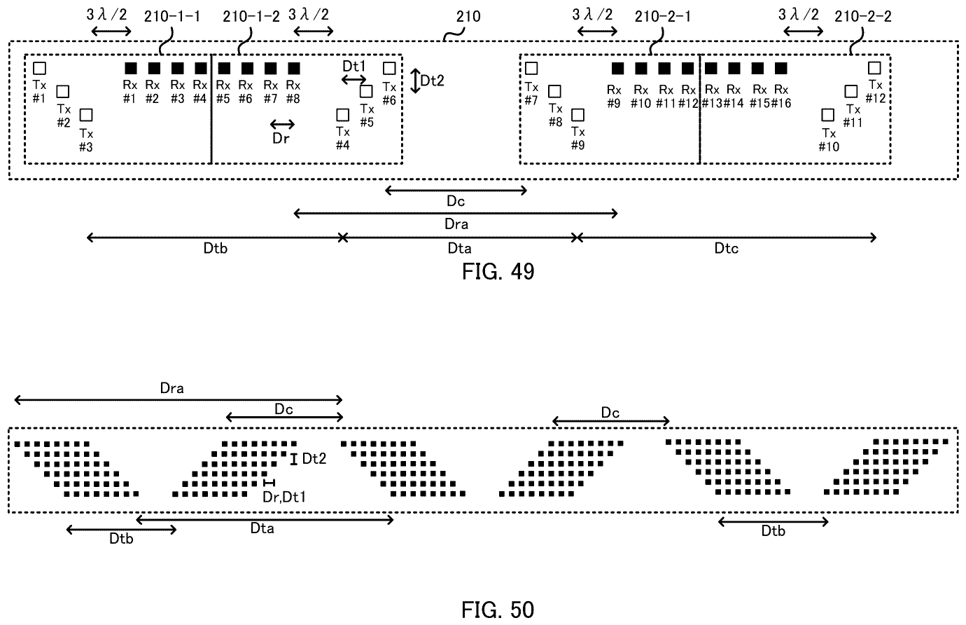

In FIGS. 48 and 49, in near regions 210-1-2 and 210-2-1 of the respective antennas, the transmitting antennas (Tx #4 to Tx #6 and Tx #7 to Tx #9) are disposed closer to camera 150, and the receiving antennas (Rx #5 to Rx #8 and Rx #9 to Rx #12) are disposed farther from camera 150. Here, the transmitting antennas (Tx #6 and Tx #7) closest to camera 150 are disposed without an offset in the second direction, and a transmitting antenna farther from camera 150 is disposed with a larger offset in the second direction.

Far regions 210-1-1 and 210-2-2 of the respective antennas are disposed such that receiving antennas (Rx #1 to Rx #4 and Rx #13 to Rx #16) are closer to camera 150 and transmitting antennas (Tx #1 to Tx #3 and Tx #10 to Tx #12) are farther from camera 150. The transmitting antennas (Tx #1 and Tx #12) farthest from camera 150 are disposed without an offset in the second direction, and a transmitting antenna closer to camera 150 is disposed with a larger offset in the second direction.

Further, the receiving antennas of each antenna are arranged at interval Dr in the first direction, and the transmitting antennas of each antenna are offset by Dt2 in the second direction orthogonal to the first direction and are arranged at interval Dt1 in the first direction.

Here, the length of the FOV of camera 150 in the first direction is defined as Dcamera, and the distance between the transmitting antennas (Tx #6 and Tx #7) disposed at the locations closest to camera 150 is defined as Dc.

In this case, by setting Dc>Dcamera, it is possible to avoid disposing antenna element 212 in the FOV of camera 150.

Further, the distance between receiving antennas (Rx #8 and Rx #9) disposed at locations closest to camera 150 in the respective antennas is defined as Dra, and the distance between transmitting antennas (Tx #4 and Tx #9) disposed at locations farthest from camera 150 in the near regions of the respective antennas is defined as Dta.

Further, in one antenna installation region 210-1, the distance between transmitting antenna (Tx #4) disposed at a location farthest from the camera in the near region and antenna system 211 (Tx #3) of the transmitting antenna disposed at a location closest to the camera in the far region is defined as Dtb.

Further, in the other antenna installation region 210-2, the distance between transmitting antenna (Tx #9) disposed at a location farthest from the camera in the near region and antenna system 211 (Tx #10) of the transmitting antenna disposed at a location closest to the camera in the far region is defined as Dtc.

In this case, Dt1, Dt2, and Dr are all λ/2. Then, for example, Dc is 12λ, Dra is 14λ, Dta is 17λ, and Dtb and Dtc are 6.5λ. Dtb and Dtc do not have to be the same. Further, Dc, Dra, Dta, Dtb, and Dtc may be other values. Further, the interval between Tx #3 and Rx #1 in the first direction, the interval between Tx #4 and Rx #8 in the first direction, the interval between Tx #9 and Rx #9 in the first direction, and the interval between Tx #10 and Rx #16 in the first direction are set to 1.5λ as an example, but may be other values and may not be the same value.

FIG. 50 illustrates a virtual receiving antenna arrangement of the opening antennas in FIG. 49. FIG. 50 can be understood in the same manner as FIG. 34. The virtual antennas when Tx #1 transmits electromagnetic waves and Rx #9 to Rx #16 receive the electromagnetic waves overlap with the virtual antennas when Tx #7 transmits electromagnetic waves and Rx #1 to Rx #8 receive the electromagnetic waves.

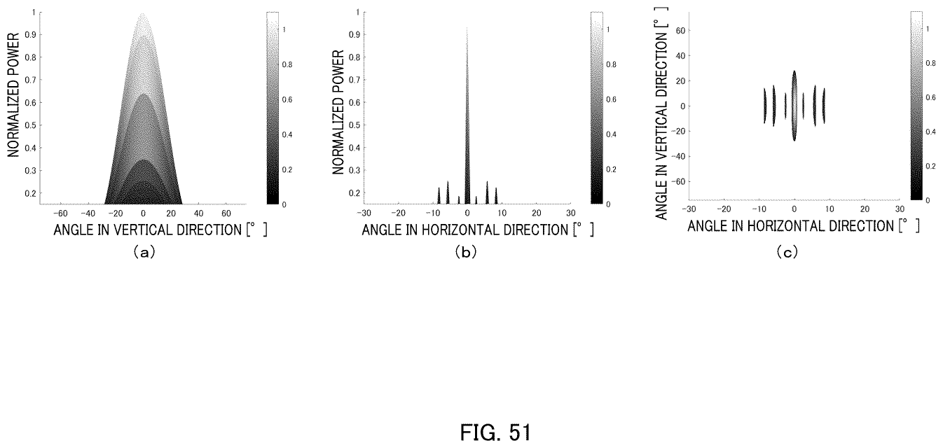

FIG. 51 illustrates the simulated angle measurement results (Fourier beamformer method) in a case where each antenna element is disposed according to FIG. 49. Part (a) in FIG. 51 illustrates power with respect to the vertical angle, part (b) in FIG. 51 illustrates power with respect to the horizontal angle, and part (c) in FIG. 51 illustrates power corresponding to the horizontal direction and the vertical direction. From parts (a) and (b) in FIG. 51, a main lobe with a reception power peak in the target object true value direction (horizontal 0 degrees and vertical 0 degrees) is detected, and from part (c) in FIG. 51, the beam width in the vertical direction is approximately 36 degrees, and the beam width in the horizontal direction is approximately 1 degree.

Even when electrode non-installation region 400 (FOV region of camera 150) is located between the antennas, the grating lobes can be suppressed by arranging antenna systems 211 of the receiving antennas of each antenna in the horizontal direction at intervals of Dr (for example, λ/2).

Further, since the aperture length of the MIMO virtual receiving antenna can be expanded in the horizontal direction and the vertical direction, the radar angle measurement performance can be improved, specifically, the angle measurement accuracy and the resolution in the horizontal direction and the vertical direction can be enhanced.

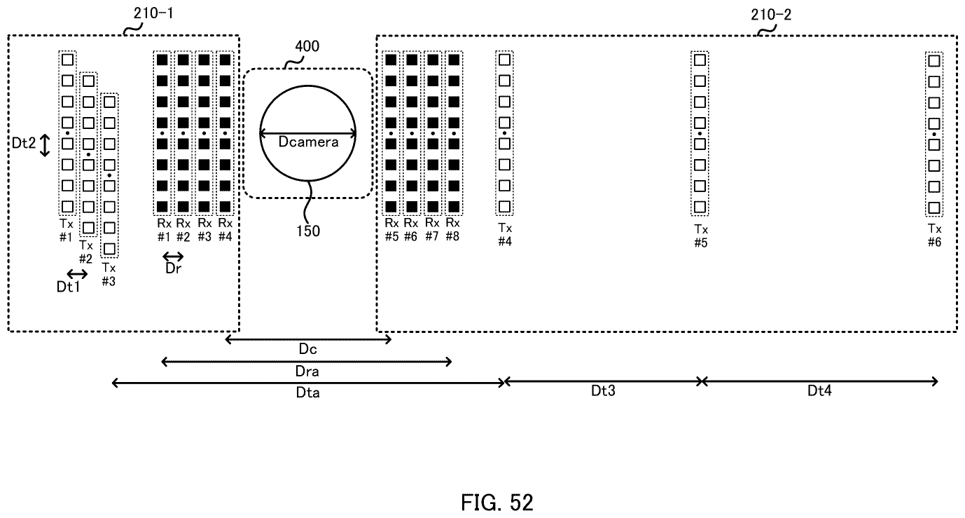

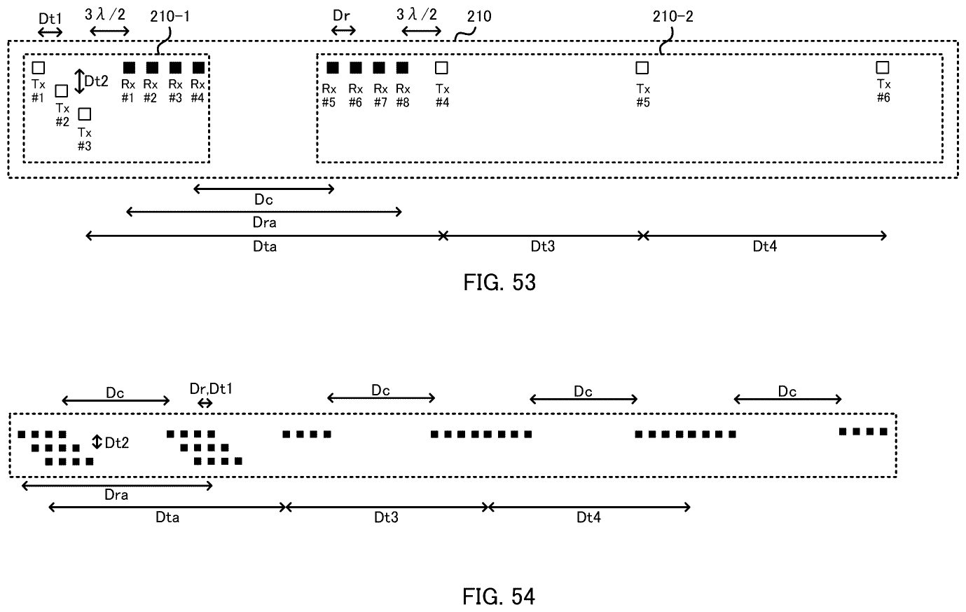

In FIGS. 52 and 53, in one antenna installation region 210-1, four receiving antennas (Rx #1 to Rx #4) are disposed closer to camera 150, transmitting antennas (Tx #1 to Tx #3) are disposed farther from camera 150, the transmitting antenna (Tx #1) farthest from camera 150 is disposed without an offset in the second direction, and a transmitting antenna closer to camera 150 is disposed with a larger offset in the second direction. Receiving antennas (Rx #1 to Rx #4) are arranged at the same interval Dr in the first direction, and transmitting antennas (Tx #1 to Tx #3) are offset by Dt2 in the second direction orthogonal to the first direction and are arranged at the same interval Dt1 in the first direction.

In the other antenna installation region 210-2, receiving antennas (Rx #5 to Rx #8) are disposed closer to camera 150, and transmitting antennas (Tx #4 to Tx #6) are disposed farther from camera 150. Receiving antennas (Rx #5 to Rx #8) are arranged at the same interval Dr in the first direction, and transmitting antennas (Tx #4 to Tx #6) are arranged at intervals Dt3 and Dt4 in the first direction.

The distance between receiving antennas (Rx #4 and Rx #5) disposed at locations closest to camera 150 in the respective antennas is defined as Dc. In this case, by setting Dc>Dcamera, it is possible to avoid placing the antenna in the FOV of camera 150.

Further, the distance between receiving antennas (Rx #1 and Rx #8) disposed at the locations farthest from camera 150 in the respective antennas is defined as Dra, and the distance between transmitting antennas (Tx #3 and Tx #4) disposed at the locations closest to camera 150 in the respective antennas is defined as Dta.

In this case, Dt1, Dt2, and Dr are all λ/2. Further, for example, Dc is 8.52, Dra is 11.5λ, Dta is 14.5λ, Dt3 is 12λ, and Dt4 is 12λ. Dc, Dra, Dta, Dt3, and Dt4 may be other values. Further, the interval between Tx #3 and Rx #1 in the first direction and the interval between Tx #4 and Rx #8 in the first direction have been set to 1.5λ as an example, but may be other values and do not have to be the same value.

FIG. 54 illustrates a virtual receiving antenna arrangement of the opening antennas in FIG. 53. FIG. 54 can be understood in the same manner as FIG. 34.

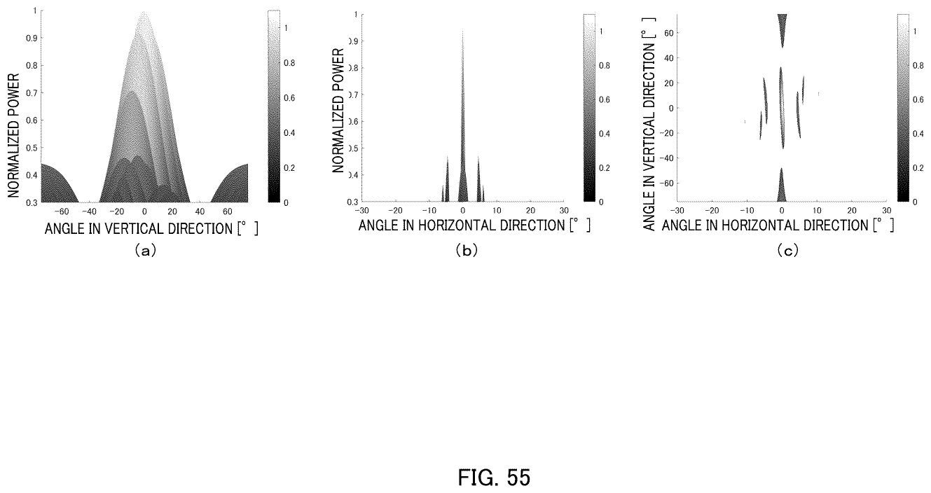

FIG. 55 illustrates the simulated angle measurement results (Fourier beamformer method) in a case where each antenna element is disposed according to FIG. 53. Part (a) in FIG. 55 illustrates power with respect to the vertical angle, part (b) in FIG. 55 illustrates power with respect to the horizontal angle, and part (c) in FIG. 55 illustrates power corresponding to the horizontal direction and the vertical direction. From parts (a) and (b) in FIG. 55, a main lobe with a reception power peak in the target object true value direction (horizontal 0 degrees and vertical 0 degrees) is detected, and from part (c) in FIG. 55, the beam width in the vertical direction is approximately 36 degrees, and the beam width in the horizontal direction is approximately 0.9 degrees.

Even when electrode non-installation region 400 (FOV region of camera 150) is located between the antennas, the grating lobes can be suppressed by arranging antenna systems 211 of the receiving antennas of each antenna in the horizontal direction at intervals of Dr (for example, λ/2).

Further, since the aperture length of the MIMO virtual receiving antenna can be expanded in the horizontal direction and the vertical direction, it is possible to enhance the radar angle measurement performance, specifically, the angle measurement accuracy and the resolution in the horizontal direction and the vertical direction.

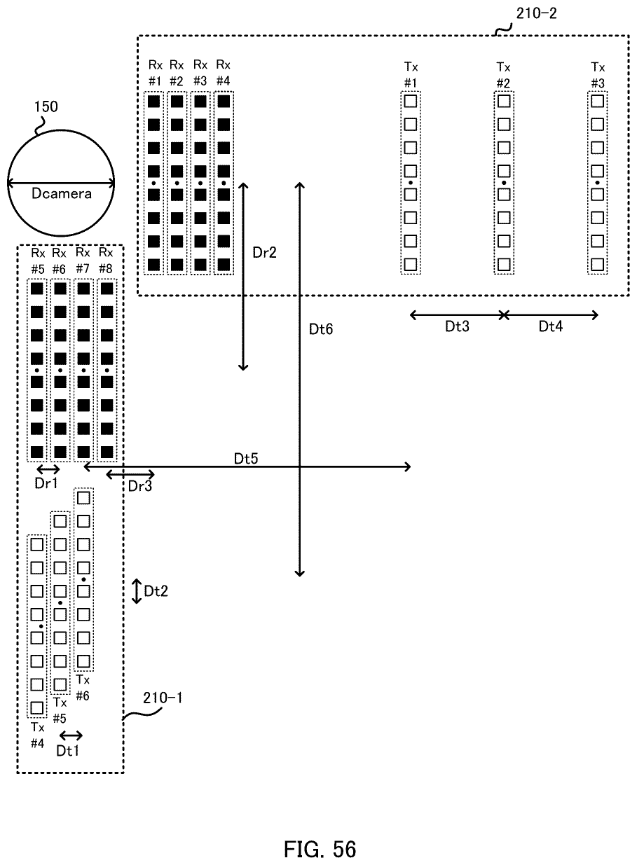

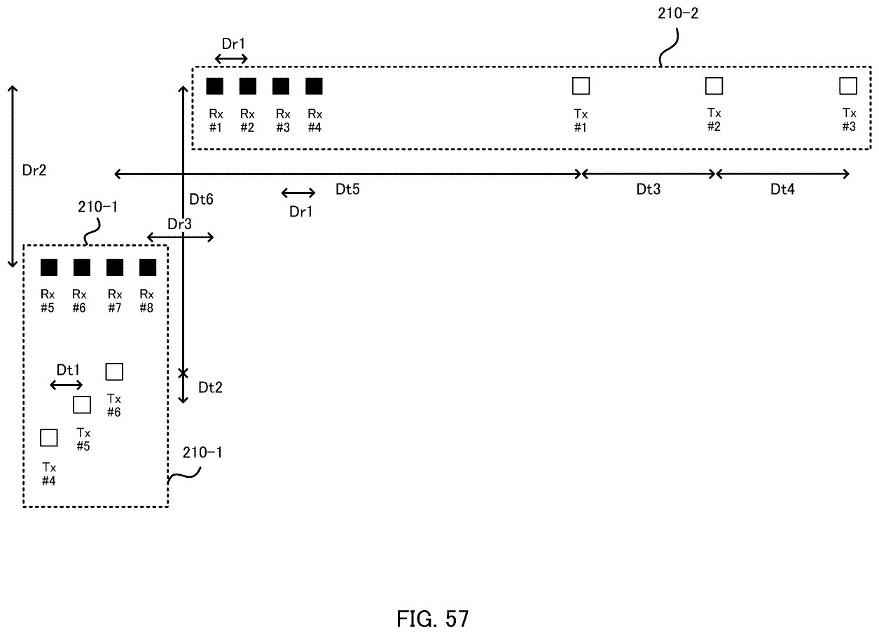

In FIGS. 56 and 57, one antenna installation region 210-1 is disposed in the second direction relative to camera 150, and the receiving antennas (Rx #5 to Rx #8) in the region close to camera 150 and the transmitting antennas (Tx #4 to Tx #6) in the region far from camera 150 are arranged in the second direction. In one antenna installation region 210-1, the receiving antennas are disposed at the same interval Dr1 in the first direction, and the transmitting antennas are disposed at the same interval Dt1 in the first direction and is offset by Dt2 in the second direction.

The antenna in one antenna installation region 210-1 is fed with power from master transceiver 140-1. The position of receiving antenna (Rx #5) (in one antenna installation region 210-1) farthest from the other antenna is the same in the second direction as that of transmitting antenna (Tx #4) (in one antenna installation region 210-1) farthest from the other antenna.

The antenna in the other antenna installation region 210-2 is disposed in the first direction relative to camera 150, and the receiving antennas (Rx #1 to Rx #4) in the region close to camera 150 and the transmitting antennas (Tx #1 to Tx #3) in the region far from camera 150 are arranged in the first direction. In the other antenna installation region 210-2, the receiving antennas are disposed at the same interval Dr1 in the first direction, and the transmitting antennas are disposed at intervals Dt3 and Dt4 in the first direction. The antenna in the other antenna installation region 210-2 is fed with power from slave transceiver 140-2.

Further, the distance in the first direction between the transmitting antenna (Tx #6) of one antenna closest to the other antenna and the transmitting antenna (Tx #1) of the other antenna closest to camera 150 is defined as Dt5, and the distance therebetween in the second direction is defined as Dt6.

Further, the distance in the first direction between receiving antenna (Rx #8) of one antenna closest to the other antenna and receiving antenna (Rx #1) of the other antenna closest to camera 150 is defined as Dr3, and the distance therebetween in the second direction is defined as Dr2.

In this case, Dt1, Dt2, and Dr1 are all λ/2. Then, for example, Dr2 is 4λ, Dr3 is λ, Dt3 and Dt4 are 2λ, Dt5 is 7λ, and Dt6 is 7.5λ. Dt3, Dt4, Dt5, Dt6, Dr2, and Dr3 may be other values.

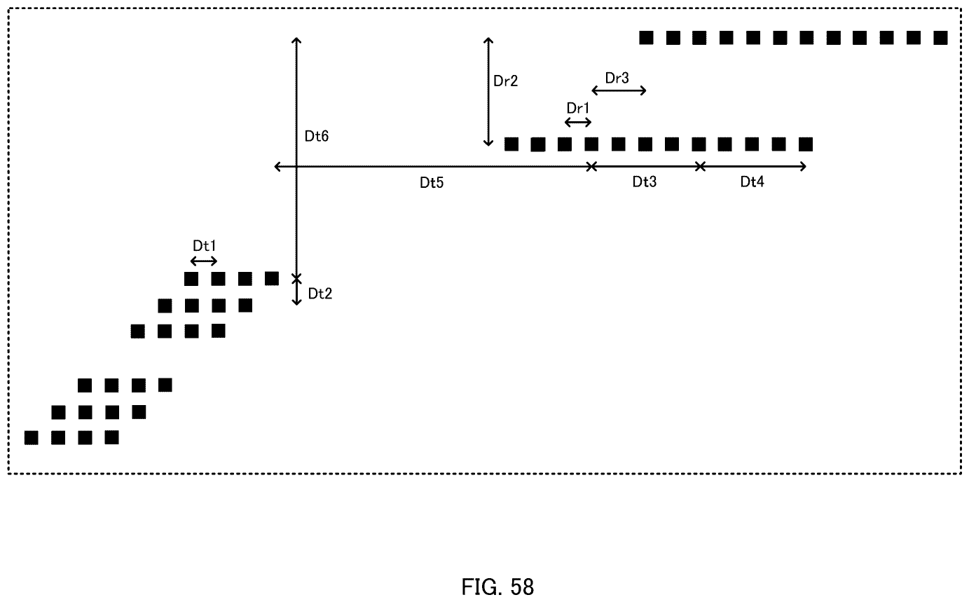

FIG. 58 illustrates a virtual receiving antenna arrangement of the opening antennas in FIG. 57. FIG. 58 can be understood in the same manner as FIG. 34.

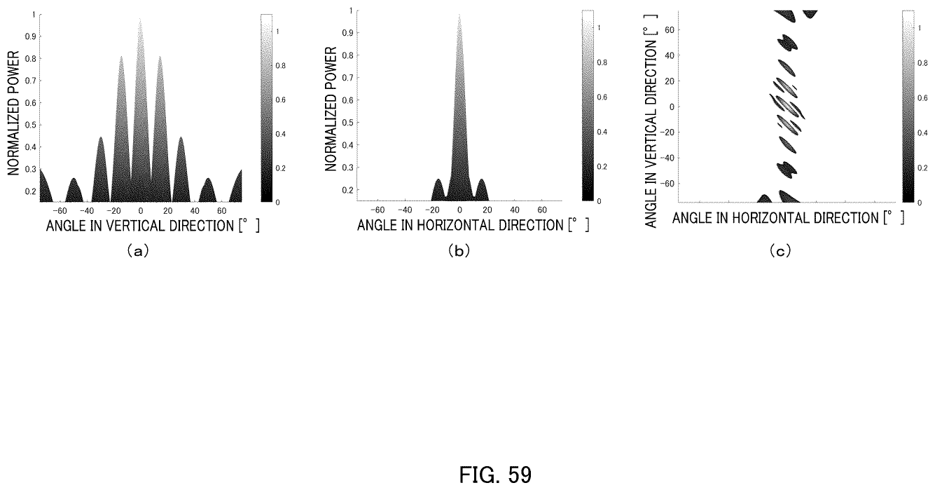

FIG. 59 illustrates the simulated angle measurement results (Fourier beamformer method) in a case where each antenna element is disposed according to FIG. 57. Part (a) in FIG. 59 illustrates power with respect to the vertical angle, part (b) in FIG. 59 illustrates power with respect to the horizontal angle, and part (c) in FIG. 59 illustrates power corresponding to the horizontal direction and the vertical direction. From parts (a) and (b) in FIG. 59, a main lobe with a reception power peak in the target object true value direction (horizontal 0 degrees and vertical 0 degrees) is detected, and from part (c) in FIG. 59, the beam width in the vertical direction is approximately 10 degrees and the beam width in the horizontal direction is approximately 9 degrees.

Since the aperture length of the MIMO virtual reception antenna can be expanded in the horizontal direction and the vertical direction, it is possible to enhance the radar angle measurement performance, specifically, the angle measurement accuracy and the resolution in the horizontal direction and the vertical direction.

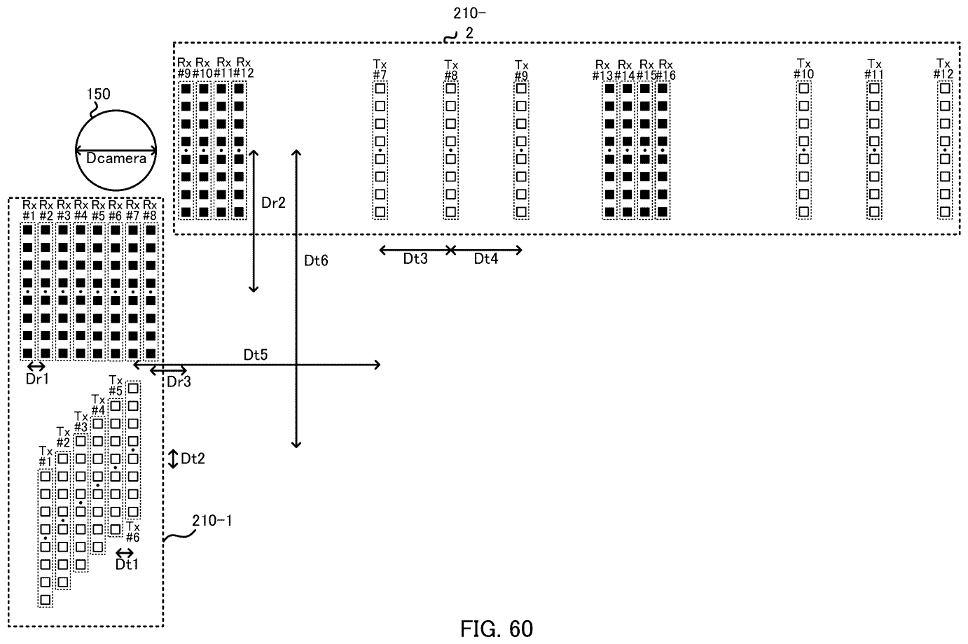

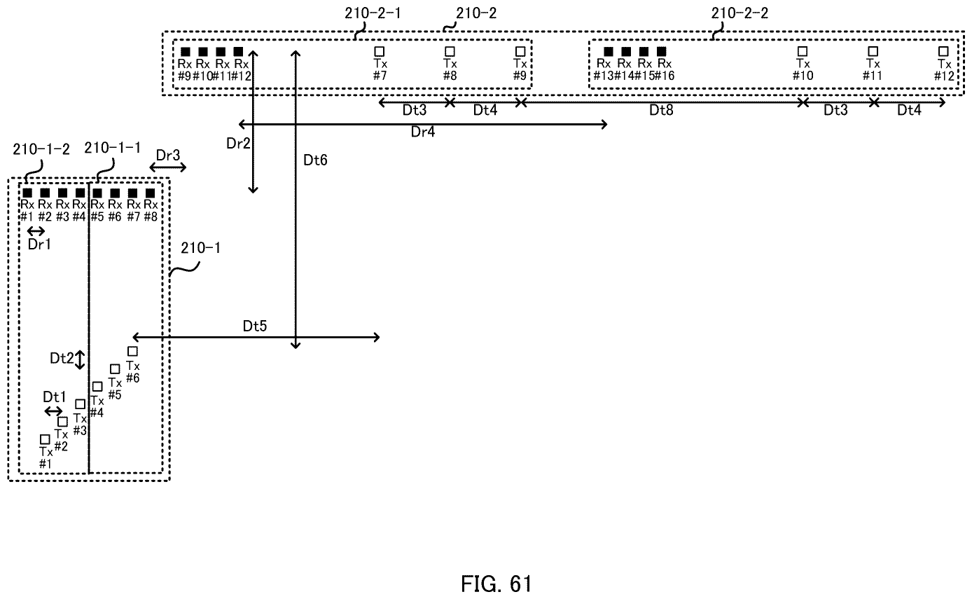

In FIGS. 60 and 61, one antenna installation region 210-1 is disposed in the second direction relative to camera 150, and eight receiving antennas (Rx #1 to Rx #8) in a region close to camera 150 and six transmitting antennas (Tx #1 to Tx #6) in a region far from camera 150 are arranged in the second direction. In one antenna installation region 210-1, the receiving antennas are disposed at the same interval Dr1 in the first direction, and the transmitting antennas are disposed at the same interval Dt1 in the first direction and is provided with an offset of Dt2 in the second direction.

Among the receiving antennas and the transmitting antennas in one antenna installation region 210-1, four receiving antennas (Rx #5 to Rx #8) and three transmitting antennas (Tx #4 to Tx #6), which are close to the other antenna, constitute one antenna installation region 210-1-1, and are fed with power from master transceiver 140-1.

Among the receiving antennas and the transmitting antennas in one antenna installation region 210-1, four receiving antennas (Rx #1 to Rx #4) and three transmitting antennas (Tx #1 to Tx #3), which are far from the other antenna, constitute another antenna installation region 210-1-2, and are fed with power from slave transceiver 140-2.

The antenna in the other antenna installation region 210-2 is disposed in the first direction relative to camera 150, and near region 210-2-1 and far region 210-2-2 are disposed to be separated from each other in the first direction. The arrangements of the antennas in near region 210-2-1 and far region 210-2-2 are the same, and four receiving antennas (Rx #9 to Rx #12 and Rx #13 to Rx #16) are disposed at the same interval Dr1 in the first direction, and transmitting antennas (Tx #7 to Tx #9 and Tx #10 to Tx #12) are disposed at intervals Dt3 and Dt4 in the first direction.

The antenna in near region 210-2-1 of the other antenna installation region 210-2 is fed with power from slave transceiver 140-3, and the antenna in far region 210-2-2 of the other antenna installation region 210-2 is fed with power from slave transceiver 140-4.

In one antenna installation region 210-1, the position in the first direction of receiving antenna (Rx #2), which is the second farthest from the other antenna installation region 210-2, is the same as the position in the first direction of transmitting antenna (Tx #1), which is the farthest from the other antenna.

The distance in the first direction between the transmitting antenna (Tx #6) of one antenna installation region 210-1 closest to the other antenna installation region 210-2 and the transmitting antenna (Tx #7) of the other antenna installation region 210-2 closest to one antenna installation region 210-1 is defined as Dt5, and the distance therebetween in the second direction is defined as Dt6.

Further, the distance in the first direction between receiving antenna (Rx #8) of one antenna installation region 210-1 closest to the other antenna and receiving antenna (Rx #9) of the other antenna installation region 210-2 closest to camera 150 is defined as Dr3, and the distance therebetween in the second direction is defined as Dr2.

Further, in the other antenna installation region 210-2, the distance in the first direction between the receiving antenna (Rx #12) farthest from the camera in near region 210-2-1 and the receiving antenna (Rx #13) closest to the camera in far region 210-2-2 is defined as Dr4, and the distance in the first direction between the transmitting antenna (Tx #9) farthest from the camera in near region 210-2-1 and the transmitting antenna (Tx #10) closest to the camera in far region 210-2-2 is defined as Dt8.

In this case, Dt1, Dt2, and Dr1 are all λ/2. Then, for example, Dr2 is 4λ, Dr3 is 1.5λ, Dr4 is 11.5λ, Dt3 and Dt4 are 4λ, Dt5 is 5λ, Dt6 is 5.5λ, and Dt8 is 8λ. Dr2, Dr3, Dr4, Dt3, Dt4, Dt5, Dt6, and Dt8 may be other values.

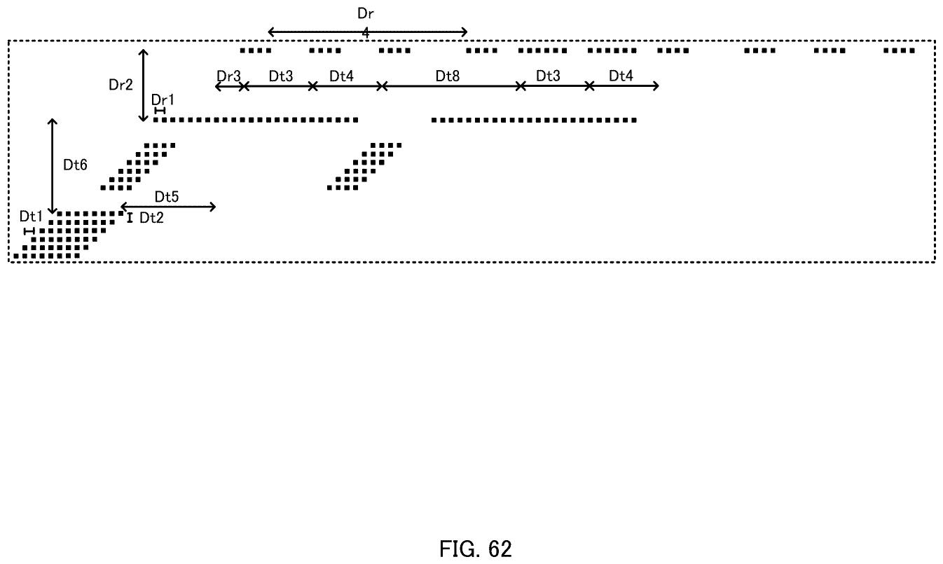

FIG. 62 illustrates a virtual receiving antenna arrangement of the opening antennas in FIG. 61. FIG. 62 can be understood in the same manner as FIG. 34.

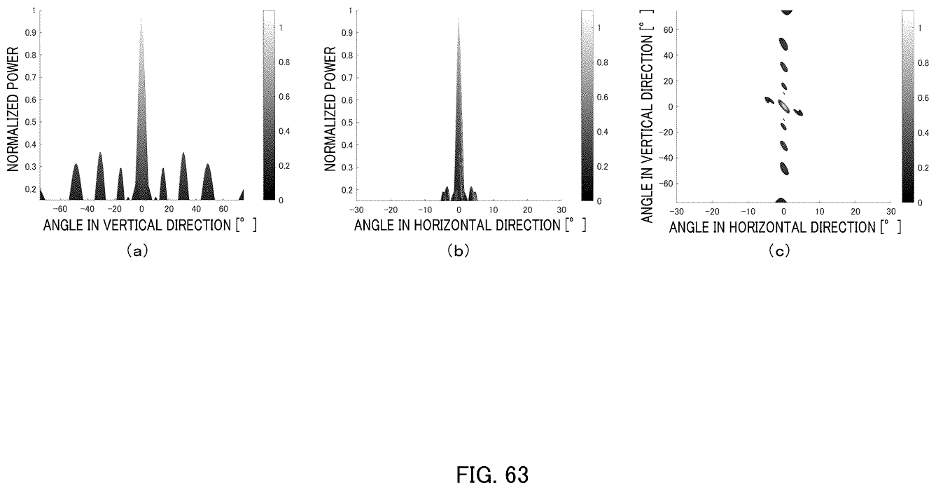

FIG. 63 illustrates the simulated angle measurement results (Fourier beamformer method) in a case where each antenna element is disposed according to FIG. 61. Part (a) in FIG. 63 illustrates power with respect to the vertical angle, part (b) in FIG. 63 illustrates power with respect to the horizontal angle, and part (c) in FIG. 63 illustrates power corresponding to the horizontal direction and the vertical direction. From parts (a) and (b) in FIG. 63, a main lobe with a reception power peak in the target object true value direction (horizontal 0 degrees and vertical 0 degrees) is detected, and from part (c) in FIG. 63, the beam width in the vertical direction is approximately 6 degrees, and the beam width in the horizontal direction is approximately 2 degrees.

Since the aperture length of the MIMO virtual receiving antenna can be expanded in the horizontal direction and the vertical direction, it is possible to enhance the radar angle measurement performance, specifically, the angle measurement accuracy and the resolution in the horizontal direction and the vertical direction.

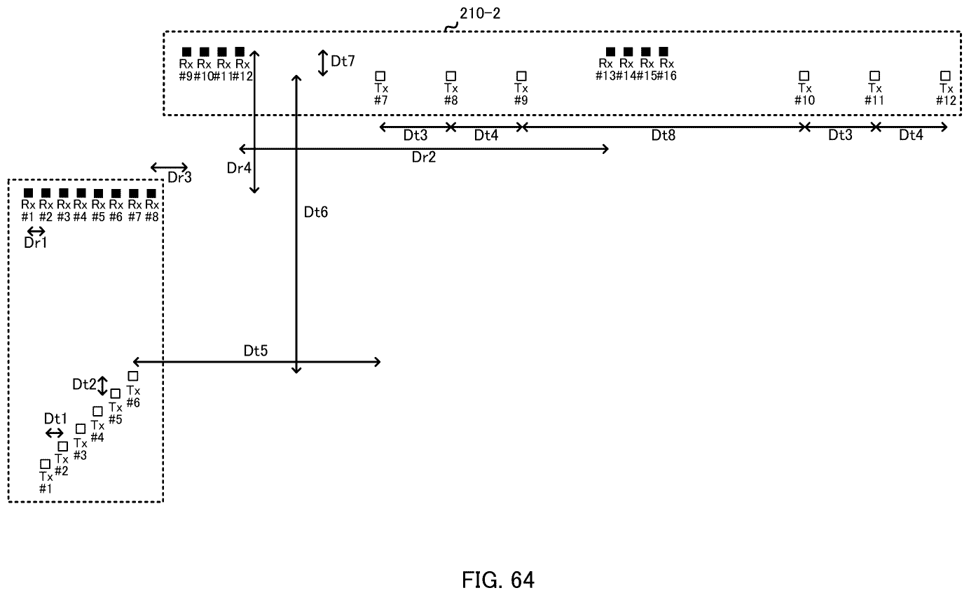

FIG. 64 illustrates an example in which offset Dt7 is provided between the transmitting antennas (Tx #7 to Tx #12) and the receiving antennas (Rx #9 to Rx #16) in the other antenna installation region 210-2 in FIG. 60. By providing an offset, it is possible to reduce the mutual coupling between the transmitting antenna and the receiving antenna.

In FIGS. 56 and 60, camera 150 is disposed in the second direction relative to one antenna installation region 210-1 and in the first direction relative to the other antenna installation region 210-2, but the present disclosure is not limited thereto. For example, camera 150 may be disposed in the first direction relative to one antenna installation region 210-1 and in the second direction relative to the other antenna installation region 210-2.

Various antenna arrangements according to the present embodiment have been described above; however, as for the arrangement of antenna systems fed with power from each transmitting/receiving apparatus, transmitting antennas may be disposed on the right side or the left side of receiving antennas as desired. Further, the arrangement of the transmitting antennas and the receiving antennas in the first direction and the second direction can be various arrangements.

Further, the transmitting antenna and the receiving antenna may be interchanged. For example, a receiving antenna may be disposed in a location described as the location for a transmitting antenna in the present disclosure, and a receiving antenna may be disposed in a location described as the location for a receiving antenna.

Further, the interval at which the antennas is disposed may be a value other than that in the present disclosure. Further, Dt1, Dt2, and Dr are all the same value, but may be different values, and in a case where the viewing angle in the radar detection range is narrow, the intervals may be larger than λ/2 (for example, approximately 0.55 to 0.8λ).

Further, which transceiver supplies power to which antenna is arbitrary, and a so-called nesting is also possible. One of the transceivers becomes a master transceiver, and the other transceivers become slave transceivers, but any transceiver may serve as the master transceiver.

Further, each antenna is described as being fed with power from transceiver 140, but may be fed with power from antenna transceiver 220.

Various embodiments have been described with reference to the drawings hereinabove. Obviously, the present disclosure is not limited to these examples. Obviously, a person skilled in the art would arrive variations and modification examples within a scope described in claims, and it is understood that these variations and modifications are within the technical scope of the present disclosure. Furthermore, the constituent elements of the above-mentioned embodiments may be combined in any manner without departing from the spirit of the present disclosure.

The expressions “section,” “processor,” “-er,” “-or,” and “-ar” used for each constituent element in the above-description may be replaced with another expression such as “circuit (circuitry),” “assembly,” “device,” “unit,” or “module.” The composite sensor may be configured to be executed by a CPU using a program stored in memory.

(1) An composite sensor according to an embodiment of the present disclosure includes: a main body including a radar controller, a camera controller, a transceiver connected to the radar controller, and an image sensor connected to the camera controller; and an antenna section connected to the transceiver and separate from the main body.

(2) An composite sensor according to an embodiment of the present disclosure has the following feature: in the composite sensor of (1), the antenna section includes a transparent electrode.

(3) An composite sensor according to an embodiment of the present disclosure has the following feature: in the composite sensor of (2), the antenna section is disposed in front of the main body, and a detection range by the image sensor and a detection range by a radar include an overlapping detection range.

(4) An composite sensor according to an embodiment of the present disclosure has the following feature: in the composite sensor of (3), the antenna section includes an electrode non-installation region in which an electrode is not wired, the electrode non-installation region being in front of the image sensor.

(5) An composite sensor according to an embodiment of the present disclosure has the following feature: in the composite sensor of (4), the antenna section includes an antenna configured to be installed in a first antenna installation region and an antenna disposed in a second antenna installation region.

(6) An composite sensor according to an embodiment of the present disclosure has the following feature: in the composite sensor of (5), the first antenna installation region and the second antenna installation region are different from each other in a first direction; and the electrode non-installation region is located between the first antenna installation region and the second antenna installation region.

(7) An composite sensor according to an embodiment of the present disclosure has the following feature: in the composite sensor of (5), a first direction of the first antenna installation region is different from a first direction of the electrode non-installation region; and a second direction of the second antenna installation region is different from a second direction of the electrode non-installation region.

(8) An composite sensor according to an embodiment of the present disclosure has the following feature: in the composite sensor of (2), the antenna section includes a plurality of transmitting antennas and a plurality of receiving antennas.

(9) An composite sensor according to an embodiment of the present disclosure has the following feature: in the composite sensor of (8), each of the transmitting antennas and the receiving antenna is constituted by a plurality of antenna elements.

(10) An composite sensor according to an embodiment of the present disclosure has the following feature: in the composite sensor of (2), the antenna section is disposed on a corner of an upper portion of a windshield of a vehicle.

(11) An composite sensor according to an embodiment of the present disclosure has the following feature: in the composite sensor of (2), the antenna section is disposed on a corner of an upper portion of a windshield of a vehicle in an L-shape having a horizontally elongated part and a vertically elongated part.

(12) An composite sensor according to an embodiment of the present disclosure has the following feature: in the composite sensor of (5), the transceiver includes a master transceiver and at least one slave transceiver; the master transceiver communicates with the radar controller; and the at least one slave transceiver communicates with the master transceiver and synchronizes with the master transceiver.

(13) An composite sensor according to an embodiment of the present disclosure has the following feature: in the composite sensor of (12), the master transceiver supplies power to the antenna included in one installation region of the first antenna installation region and the second antenna installation region; and the at least one slave transceiver supplies power to the antenna included in another installation region of the first antenna installation region and the second antenna installation region.

(14) An composite sensor according to an embodiment of the present disclosure has the following feature: in the composite sensor of (12), one slave transceiver included in the at least one slave transceiver supplies power to the antenna included in one installation region of the first antenna installation region and the second antenna installation region.

(15) An composite sensor according to an embodiment of the present disclosure has the following feature: in the composite sensor of (12), a slave transceiver included in the at least one slave transceiver supplies power to the antenna included in the first antenna installation region; and a slave transceiver other than the slave transceiver and included in the at least one slave transceiver supplies power to the antenna included in the second antenna installation region.

(16) An composite sensor according to an embodiment of the present disclosure has the following feature: in the composite sensor of (5), one of a receiving antenna and a transmitting antenna each included in at least one of the antenna in the first antenna installation region and/or the antenna in the second antenna installation region is arranged in a first direction, and another one of the receiving antenna and the transmitting antenna is arranged in the first direction with an offset in a second direction different from the first direction.

(17) An composite sensor according to an embodiment of the present disclosure has the following feature: in the composite sensor of (16), the offset in the second direction in the first antenna installation region and the offset in the second direction in the second antenna installation region are different from each other

(18) An composite sensor according to an embodiment of the present disclosure has the following feature: in the composite sensor of (5), one of a receiving antenna and a transmitting antenna each included in the antenna in the first antenna installation region and in the antenna in the second antenna installation region is arranged in a first direction; another one of the receiving antenna and the transmitting antenna is arranged in the first direction with an offset in a second direction different from the first direction; and the offset in the second direction is the same in the first antenna installation region and the second antenna installation region.

(19) An composite sensor according to an embodiment of the present disclosure has the following feature: in the composite sensor of (5), one of a receiving antenna and a transmitting antenna each included in the antenna in the first antenna installation region is arranged in a first direction different from a second direction with an offset in the second direction; and one of a receiving antenna and a transmitting antenna included in the antenna in the second antenna installation region is arranged at a wider interval than an aperture length of another one of the receiving antenna and the transmitting antenna arranged in the first direction in the first antenna installation region and the second antenna installation region.

(20) An composite sensor according to an embodiment of the present disclosure has the following feature: in the composite sensor in (5), one of a receiving antenna and a transmitting antenna each included in the antenna in the first antenna installation region and in the antenna in the second antenna installation region is arranged in a first direction; another one of the receiving antenna and the transmitting antenna included in the antenna in the first antenna installation region is arranged in the first direction with an offset in a second direction different from the first direction; and another one of the receiving antenna and the transmitting antenna included in the antenna in the second antenna installation region is arranged at an interval wider than an aperture length of the one of the receiving antenna and the transmitting antenna arranged in the first direction in the first antenna installation region and the second antenna installation region.

(21) An composite sensor according to an embodiment of the present disclosure has the following feature: in the composite sensor in (5), the antenna section includes an antenna transceiver; and the antenna transceiver communicates with the transceiver to supply power to an antenna in the antenna section.

(22) An composite sensor according to an embodiment of the present disclosure has the following feature: in the composite sensor in (21), the antenna transceiver includes a master antenna transceiver and at least one slave antenna transceiver; the master antenna transceiver is connected to the transceiver; and the at least one slave antenna transceiver is connected to the master antenna transceiver and synchronizes with the master antenna transceiver.

(23) An composite sensor according to an embodiment of the present disclosure has the following feature: in the composite sensor of (22), the master antenna transceiver supplies power to the antenna included in one of the first antenna installation region and the second antenna installation region, and the at least one slave antenna transceiver supplies power to the antenna included in another one of the first antenna installation region and the second antenna installation region.

(24) An composite sensor according to an embodiment of the present disclosure has the following feature: in the composite sensor in (22), one slave antenna transceiver included in the at least one slave antenna transceiver supplies power to the antenna included in one of the first antenna installation region and the second antenna installation region.

(25) An composite sensor according to an embodiment of the present disclosure has the following feature: in the composite sensor of (22), a slave antenna transceiver included in the at least one slave antenna transceiver supplies power to the antenna in the first antenna installation region; and a slave antenna transceiver other than the the slave antenna transceiver and included in the at least one slave antenna transceiver supplies power to the antenna in the second antenna installation region.

(26) An composite sensor according to an embodiment of the present disclosure has the following feature: in the composite sensor of (22), one of a receiving antenna and a transmitting antenna each included in at least one of the antenna in the first antenna installation region and/or the antenna in the second antenna installation region is arranged in a first direction, and another one of the receiving antenna and the transmitting antenna is disposed in the first direction with an offset in a second direction different from the first direction.

(27) An composite sensor according to an embodiment of the present disclosure has the following feature: in the composite sensor of (26), the offset in the second direction in the first antenna installation region and the offset in the second direction in the second antenna installation region are different from each other.

(28) An composite sensor according to an embodiment of the present disclosure has the following feature: in the composite sensor of (22), one of a receiving antenna and a transmitting antenna each included in at least one of the antenna in the first antenna installation region and/or the antenna in the second antenna installation region is arranged in a first direction; another one of the receiving antenna and the transmitting antenna is arranged in the first direction with an offset in a second direction different from the first direction; and the offset in the second direction is the same in the first antenna installation region and the second antenna installation region.

(29) An composite sensor according to an embodiment of the present disclosure has the following feature: in the composite sensor of (22), one of a receiving antenna and a transmitting antenna each included in the antenna in the first antenna installation region is arranged in a first direction different from a second direction with an offset in the second direction; and one of a receiving antenna and a transmitting antenna included in the antenna in the second antenna installation region is arranged at a wider interval than an aperture length of another one of the receiving antenna and the transmitting antenna arranged in the first direction in the first antenna installation region and the second antenna installation region.

(30) An composite sensor according to an embodiment of the present disclosure has the following feature: in the composite sensor in (22), one of a receiving antenna and a transmitting antenna each included in the antenna in the first antenna installation region and in the antenna in the second antenna installation region is arranged in a first direction; another one of the receiving antenna and the transmitting antenna included in the antenna in the first antenna installation region is arranged in the first direction with an offset in a second direction different from the first direction; and another one of the receiving antenna and the transmitting antenna included in the antenna in the second antenna installation region is arranged at an interval wider than an aperture length of the one of the receiving antenna and the transmitting antenna arranged in the first direction in the first antenna installation region and the second antenna installation region.

(31) A vehicle in an embodiment of the present disclosure includes, mounted thereon, the composite sensor of (1).

While various embodiments have been described herein above, it is to be appreciated that various changes in form and detail may be made without departing from the spirit and scope of the disclosure(s) presently or hereafter claimed.

The disclosure of Japanese Patent Application No. 2024-039976, filed on Mar. 14, 2024, including the specification, drawings and abstract, is incorporated herein by reference in its entirety.

### INDUSTRIAL APPLICABILITY

An aspect of the present disclosure is useful for a composite sensor.

### REFERENCE SIGNS LIST

100 Main body
110 Interface
120 Radar controller
130 Camera controller
140 Transceiver
150 Image sensor
200 Antenna section
210 Antenna installation region
211 Antenna system
212 Antenna element
213 Power supply line
214 Phase center
220 Antenna transceiver
230 Power supply line
300 Cable
400 Region in which electrode is not wired

1. A composite sensor comprising:
a main body including a radar control circuitry, a camera control circuitry, a transceiver connected to the radar control circuitry, and an image sensor connected to the camera control circuitry; and
an antenna section configured to be connected to the transceiver and separate from the main body.

2. The composite sensor according to claim 1, wherein
the antenna section includes a transparent electrode.

3. The composite sensor according to claim 1, wherein
the antenna section is disposed in front of the main body, and a detection range by the image sensor and a detection range by a radar include an overlapping detection range.

4. The composite sensor according to claim 1, wherein
the antenna section includes an electrode non-installation region in which an electrode is not wired, the electrode non-installation region being in front of the image sensor.

5. The composite sensor according to claim 4, wherein:
the antenna section includes an antenna installed in a first antenna installation region and an antenna disposed in a second antenna installation region;
the first antenna installation region and the second antenna installation region are different from each other in a first direction; and
the electrode non-installation region is located between the first antenna installation region and the second antenna installation region.

6. The composite sensor according to claim 4, wherein:
the antenna section includes an antenna installed in a first antenna installation region and an antenna disposed in a second antenna installation region;
a first direction of the first antenna installation region is different from a first direction of the electrode non-installation region; and
a second direction of the second antenna installation region is different from a second direction of the electrode non-installation region.

7. The composite sensor according to claim 1, wherein
the antenna section is configured to be disposed on a corner of an upper portion of a windshield of a vehicle.

8. The composite sensor according to claim 1, wherein
the antenna section is configured to be disposed on a corner of an upper portion of a windshield of a vehicle in an L-shape having a horizontally elongated part and a vertically elongated part.

9. The composite sensor according to claim 1, wherein:
the transceiver includes a master transceiver and at least one slave transceiver;
the master transceiver which, in operation, communicates with the radar controller; and
the at least one slave transceiver which, in operation, communicates with the master transceiver and synchronizes with the master transceiver.

10. The composite sensor according to claim 9, wherein:
the antenna section includes an antenna installed in a first antenna installation region and an antenna disposed in a second antenna installation region;
the master transceiver which, in operation, supplies power to the antenna included in one installation region of the first antenna installation region and the second antenna installation region; and
the at least one slave transceiver which, in operation, supplies power to the antenna included in another installation region of the first antenna installation region and the second antenna installation region.

11. The composite sensor according to claim 9, wherein:
the antenna section includes an antenna installed in a first antenna installation region and an antenna installed in a second antenna installation region; and
one slave transceiver included in the at least one slave transceiver which, in operation, supplies power to the antenna included in one installation region of the first antenna installation region and the second antenna installation region.

12. The composite sensor according to claim 9, wherein:
the antenna section includes an antenna installed in a first antenna installation region and an antenna installed in a second antenna installation region;
a first slave transceiver which, in operation, supplies power to the antenna included in the first antenna installation region, the first slave transceiver being included in the at least one slave transceiver; and
a second slave transceiver which, in operation, supplies power to the antenna included in the second antenna installation region, the second slave transceiver being other than the first slave transceiver and being included in the at least one slave transceiver.

13. The composite sensor according to claim 1, wherein:
the antenna section includes an antenna installed in a first antenna installation region and an antenna installed in a second antenna installation region; and
one of a receiving antenna and a transmitting antenna each included in at least one of the antenna in the first antenna installation region and/or the antenna in the second antenna installation region is configured to be arranged in a first direction, and another one of the receiving antenna and the transmitting antenna is configured to be arranged in the first direction with an offset in a second direction different from the first direction.

14. The composite sensor according to claim 13, wherein
the offset in the second direction in the first antenna installation region and the offset in the second direction in the second antenna installation region are configured to be different from each other.

15. The composite sensor according to claim 13, wherein
the offset in the second direction is the same in the first antenna installation region and the second antenna installation region.

16. The composite sensor according to claim 1, wherein:
the antenna section includes an antenna installed in a first antenna installation region and an antenna installed in a second antenna installation region;
one of a receiving antenna and a transmitting antenna each included in the antenna in the first antenna installation region is configured to be arranged in a first direction different from a second direction with an offset in the second direction; and
one of a receiving antenna and a transmitting antenna included in the antenna in the second antenna installation region is configured to be arranged at a wider interval than an aperture length of another one of the receiving antenna and the transmitting antenna arranged in the first direction in the first antenna installation region and the second antenna installation region.

17. The composite sensor according to claim 1, wherein:
the antenna section includes an antenna installed in a first antenna installation region and an antenna installed in a second antenna installation region;
one of a receiving antenna and a transmitting antenna each included in the antenna in the first antenna installation region and in the antenna in the second antenna installation region is configured to be arranged in a first direction;
another one of the receiving antenna and the transmitting antenna included in the antenna in the first antenna installation region is configured to be arranged in the first direction with an offset in a second direction different from the first direction; and
another one of the receiving antenna and the transmitting antenna included in the antenna in the second antenna installation region is configured to be arranged at an interval wider than an aperture length of the one of the receiving antenna and the transmitting antenna arranged in the first direction in the first antenna installation region and the second antenna installation region.

18. The composite sensor according to claim 1, wherein:
the antenna section includes an antenna transceiver; and
the antenna transceiver which, in operation, communicates with the transceiver to supply power to an antenna in the antenna section.

19. The composite sensor according to claim 18, wherein:
the antenna transceiver includes a master antenna transceiver and at least one slave antenna transceiver;
the master antenna transceiver is connected to the transceiver; and
the at least one slave antenna transceiver is connected to the master antenna transceiver and synchronizes with the master antenna transceiver.

20. A vehicle comprising, mounted thereon, the composite sensor according to claim 1.
